(19) United States
(12) Patent Application Publication
(10) Pub. No.: US 2025/0340035 A1
(43) Pub. Date: Nov. 6, 2025

(54) METHOD OF CHANGING TOOLS FOR A PRESS

(71) Applicant: BROWN LLC, Beaverton, MI (US)

(72) Inventor: Peter Haase, Beaverton, MI (US)

(21) Appl. No.: 19/069,608

(22) Filed: Mar. 4, 2025

Related U.S. Application Data
(60) Provisional application No. 63/642,281, filed on May 3, 2024.

(51) Int. Cl. B30B 15/02; B62B 3/10

(52) U.S. Cl. CPC B30B 15/028; B30B 15/026; B62B 3/10

(57) ABSTRACT

A system for loading and unloading top and bottom tools in a press machine comprises a cart, an upper platen, first and second upper platen loading arms, a lower platen, and first and second lower platen loading arms. The cart supports the top and bottom tools and includes a latch to couple to the press machine and a conveyor mechanism to move the tools. The upper platen, positioned in the press machine, retains the top tool and includes top tool clamps to clamp the top tool. The first and second upper platen loading arms include rollers to fit into roller slots of the top tool. The lower platen, positioned in the press machine beneath the upper platen, retains the bottom tool and includes bottom tool clamps to clamp the bottom tool. The first and second lower platen loading arms include tracks to fit into T-slots of the bottom tool.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/642,281; titled “METHOD OF CHANGING TOOLS FOR A PRESS”; and filed May 3, 2024. The Provisional Application is hereby incorporated by reference, in its entirety, into the current patent application.

### FIELD OF THE INVENTION

Embodiments of the current invention relate to systems and methods for changing tools that are utilized with pressing equipment.

### BACKGROUND OF THE INVENTION

A press machine generally provides a pressing operation, that is, applying pressure, to a blank such as paper or plastic film or sheet in order to shape, score, fold, cut, and so forth, the blank during the production of a product, such as a plate or covered container. The press machine may be positioned in and operate as one of a plurality of machines, components, or stations in a forming or thermoforming system. The press machine typically utilizes a top tool and a bottom tool, in combination, to perform the pressing operation. The top tool performs shaping, scoring, folding, cutting, or the like on an upper surface or aspect of the blank during production. The bottom tool performs shaping, scoring, folding, cutting, or the like on a lower surface or aspect of the blank during production.

The background discussion is intended to provide information related to the present invention which is not necessarily prior art.

### SUMMARY OF THE INVENTION

Embodiments of the current invention provide systems and methods for efficiently changing a top tool and a bottom tool in a press machine. One of the systems broadly comprises a cart, an upper platen, first and second upper platen loading arms, a lower platen, and first and second lower platen loading arms. The cart receives and temporarily retains the top tool and the bottom tool and includes a latch assembly and a conveyor mechanism. The latch assembly is configured to couple the cart to the press machine. The conveyor mechanism is configured to move the top tool and the bottom tool between the cart and the press machine. The upper platen is positioned in the press machine and is configured to retain the top tool. The upper platen includes a plurality of top tool clamps to clamp to first and second T-slots of the top tool. The first upper platen loading arm is coupled to a left side of a front surface of the upper platen and includes a first plurality of rollers to fit in a left roller slot of the top tool. The second upper platen loading arm is coupled to a right side of the front surface of the upper platen and includes a second plurality of rollers to fit in a right roller slot of the top tool. The lower platen is positioned in the press machine beneath the upper platen and is configured to retain the bottom tool. The lower platen includes a plurality of bottom tool clamps to clamp to third and fourth T-slots of the bottom tool. The first lower platen loading arm is positioned on a left side of a front surface of the lower platen and includes a first track to fit into the third T-slot of the bottom tool. The second lower platen loading arm is positioned on a right side of the front surface of the lower platen and includes a second track to fit into the fourth T-slot of the bottom tool.

Another embodiment of the current invention provides a method for loading a top tool and a bottom tool in a press machine. The method comprises latching a cart to the press machine; placing the top tool and the bottom tool on the cart; rotating first and second upper platen loading arms on an upper platen and first and second lower platen loading arms on a lower platen such that the first and second upper platen loading arms and the first and second lower platen loading arms each extend outward; connecting a short tool coupler to the bottom tool; moving the top tool and the bottom tool by a first distance so that the top tool engages with the upper platen loading arms and the bottom tool engages with the lower platen loading arms; removing the short tool coupler from the bottom tool; connecting a long tool coupler to the top tool and the bottom tool; raising the upper platen and lowering the lower platen, which separates the top tool and the bottom tool; moving the top tool and the bottom tool by a second distance so that the bottom tool engages with a stop on the lower platen; lowering the upper platen and raising the lower platen; engaging the top tool clamps to clamp the top tool to the upper platen; engaging the bottom tool clamps to clamp the bottom tool to the lower platen; and removing the long tool coupler from the top tool and the bottom tool.

Yet another embodiment of the current invention provides a method for unloading a top tool and a bottom tool in a press machine. The method comprises latching a cart to the press machine; connecting a long tool coupler to the top tool and the bottom tool; rotating first and second upper platen loading arms on an upper platen and first and second lower platen loading arms on a lower platen such that the first and second upper platen loading arms and the first and second lower platen loading arms each extend outward; raising an upper platen and lowering a lower platen; disengaging a plurality of top tool clamps to unclamp the top tool from the upper platen; disengaging a plurality of bottom tool clamps to unclamp the bottom tool from the lower platen; moving the top tool and the bottom tool toward the cart; raising the lower platen and lowering the upper platen; removing the long tool coupler from the top tool and the bottom tool; connecting a short tool coupler to the bottom tool; moving the top tool and the bottom tool onto the cart; removing the short tool coupler from the bottom tool; and removing the top tool and the bottom tool from the cart.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRA WINGS

Embodiments of the current invention are described in detail below with reference to the attached drawing figures, wherein:

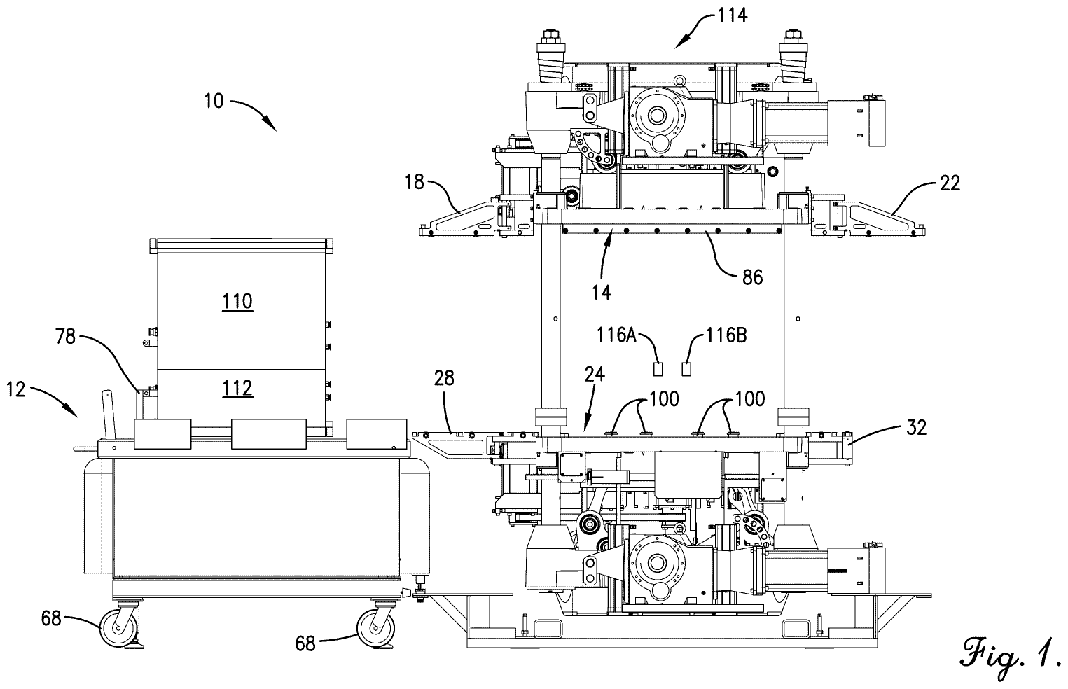

FIG. 1 is a side view of a system, constructed in accordance with various embodiments of the current invention, for changing a top tool and a bottom tool in a press machine, the system including a cart, an upper platen, and a lower platen;

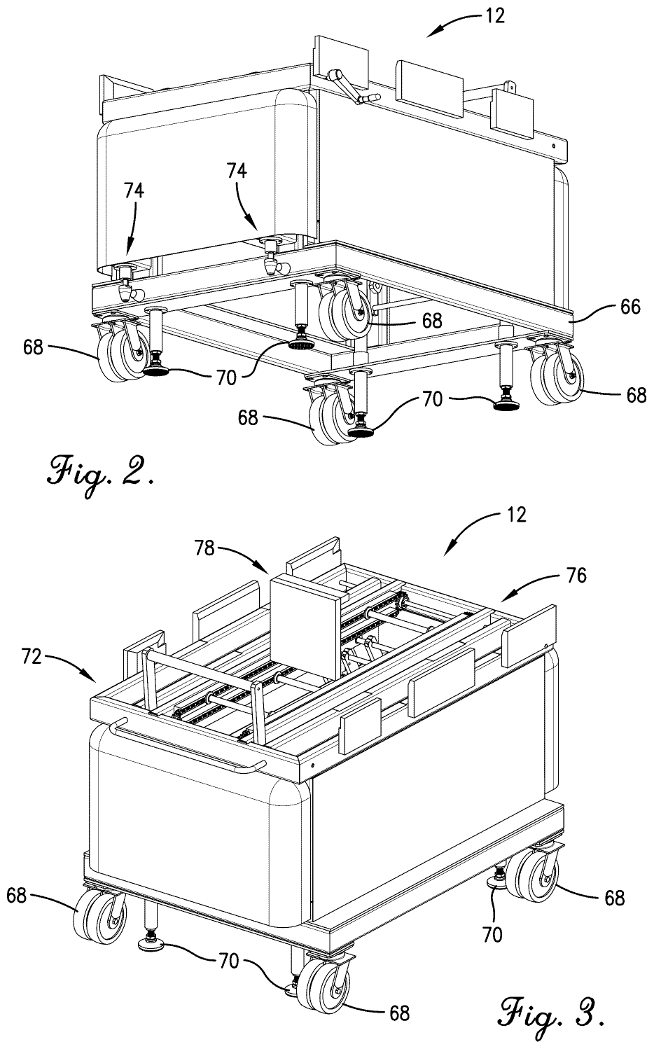

FIG. 2 is a lower perspective view of the cart;

FIG. 3 is an upper perspective view of the cart;

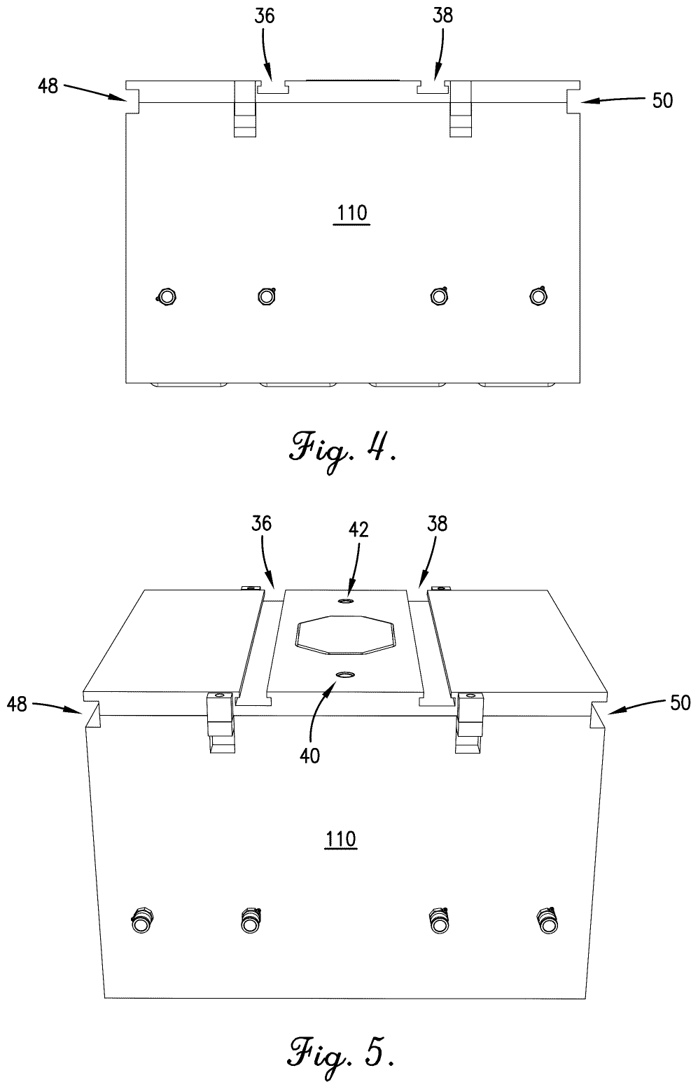

FIG. 4 is a front view of the top tool;

FIG. 5 is an upper perspective view of the top tool;

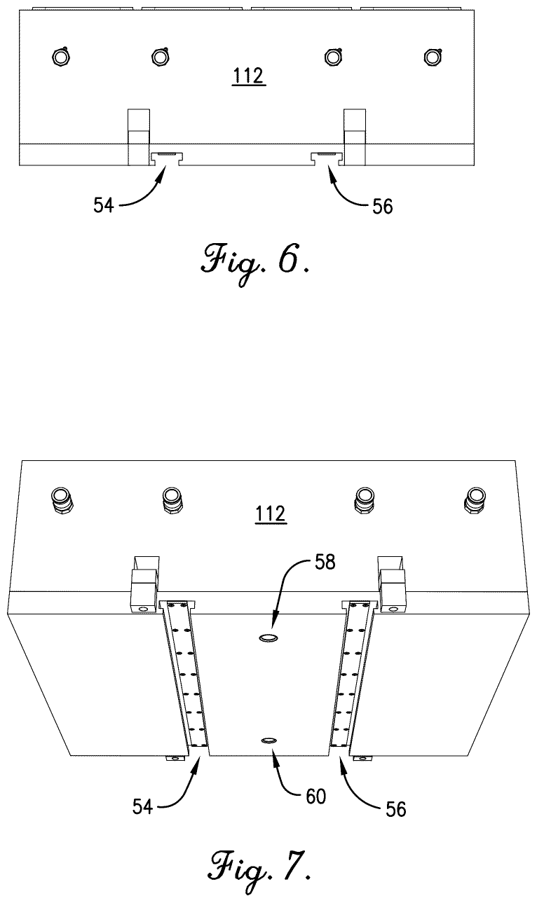

FIG. 6 is a front view of the bottom tool;

FIG. 7 is a lower perspective view of the bottom tool;

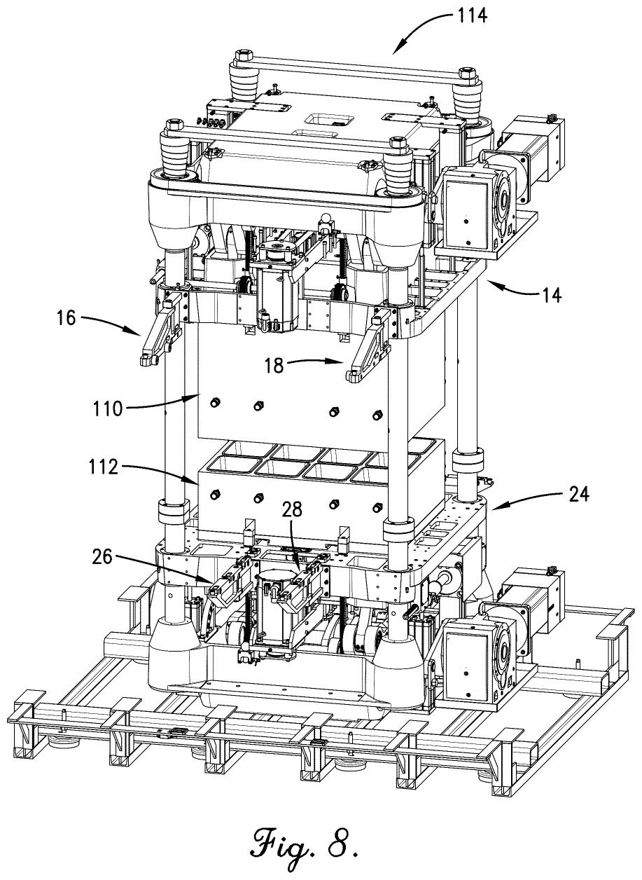

FIG. 8 is an upper perspective view of the press machine including the top tool and the bottom tool;

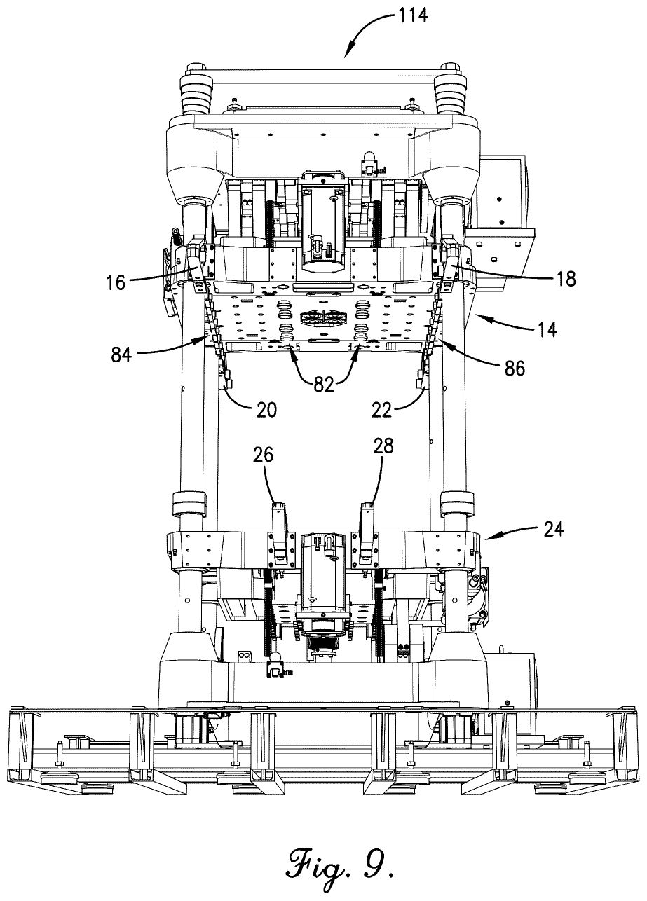

FIG. 9 is a lower perspective view of the press machine without the top tool and the bottom tool;

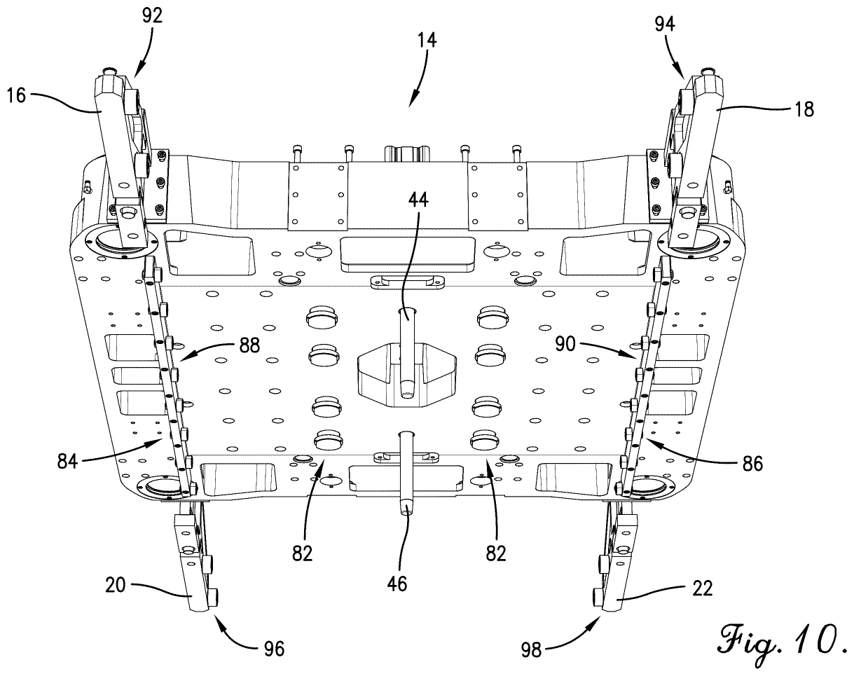

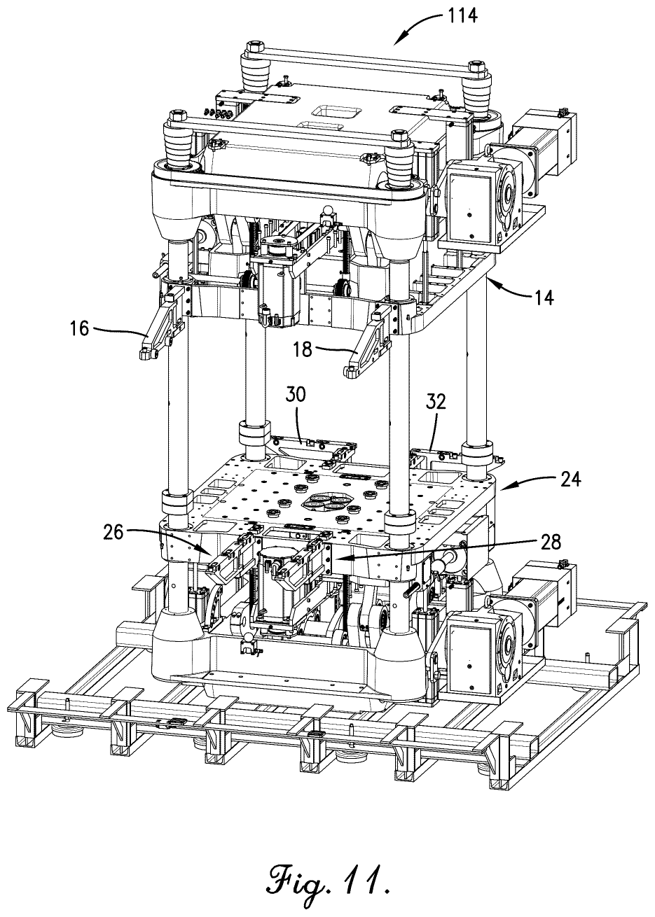

FIG. 10 is a lower perspective view of the upper platen;

FIG. 11 is an upper perspective view of the press machine without the top tool and the bottom tool;

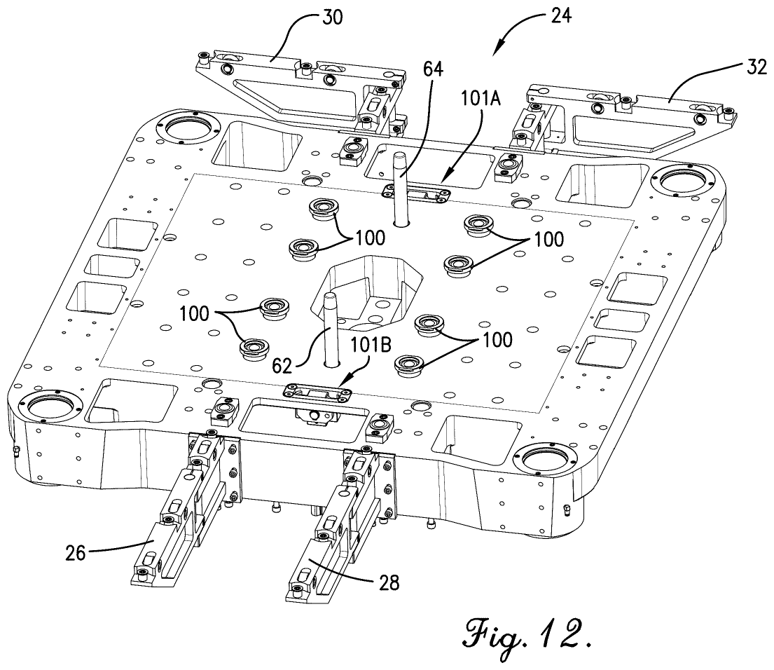

FIG. 12 is an upper perspective view of the lower platen;

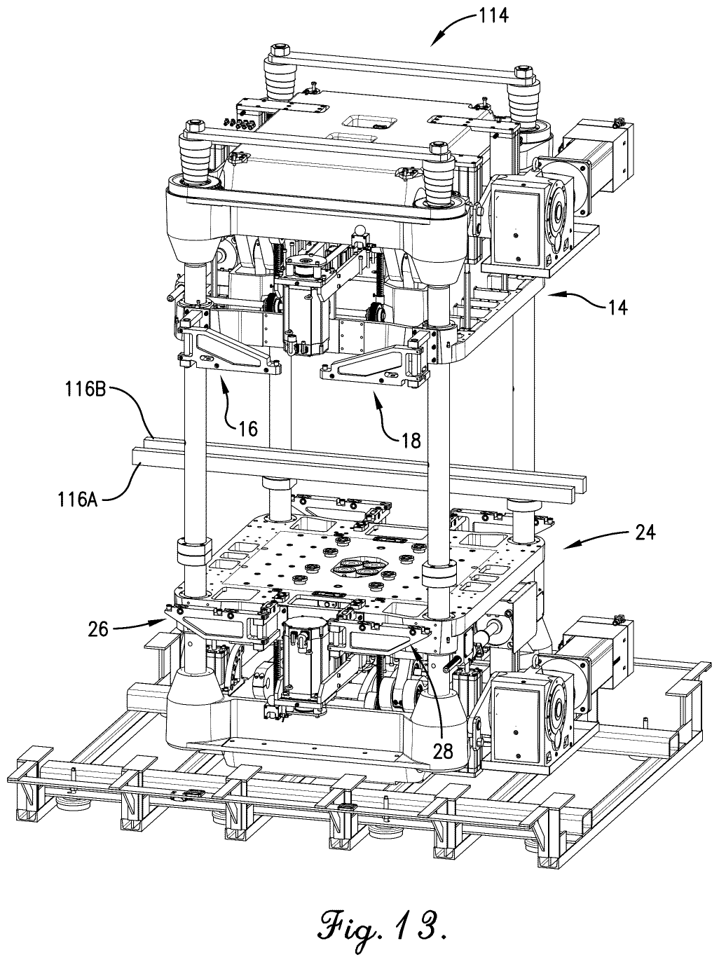

FIG. 13 is an upper perspective view of the press machine without the top tool and the bottom tool and including transport rails for transporting material to be pressed in the press machine;

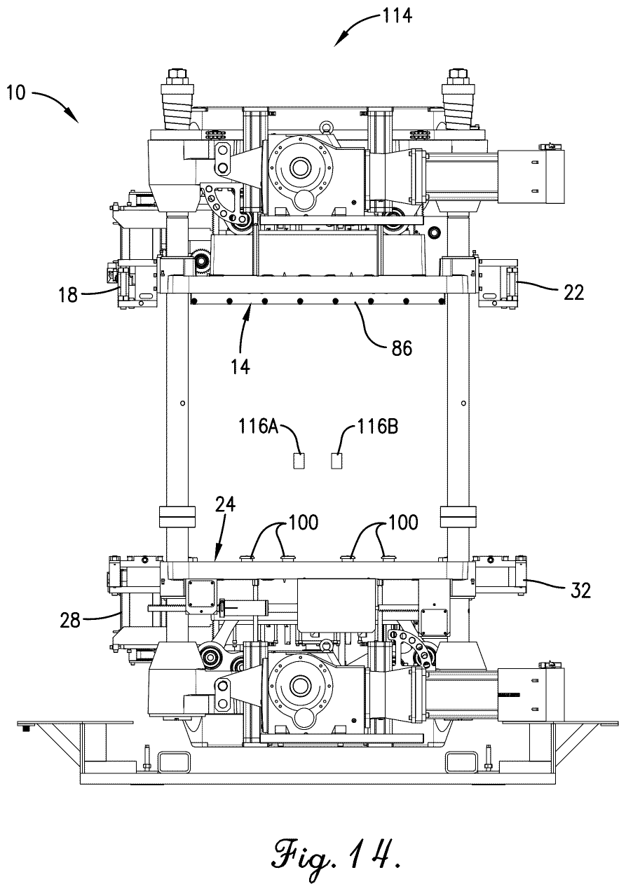

FIG. 14 is a side view of the press machine without the top tool and the bottom tool and including transport rails;

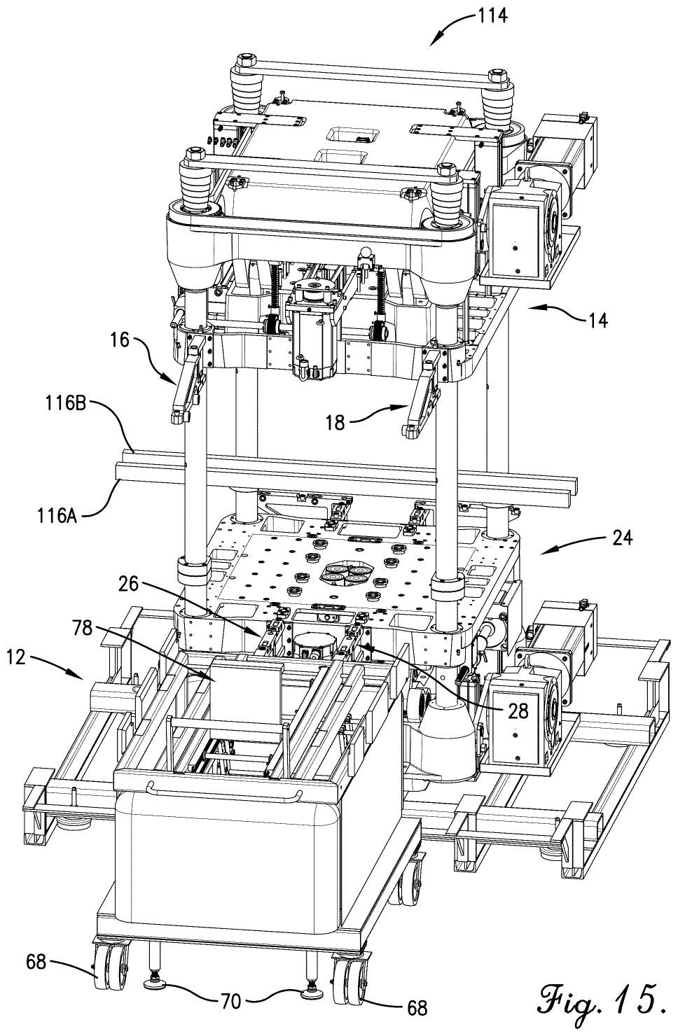

FIG. 15 is an upper perspective view of the press machine with the cart attached and without the top tool and the bottom tool;

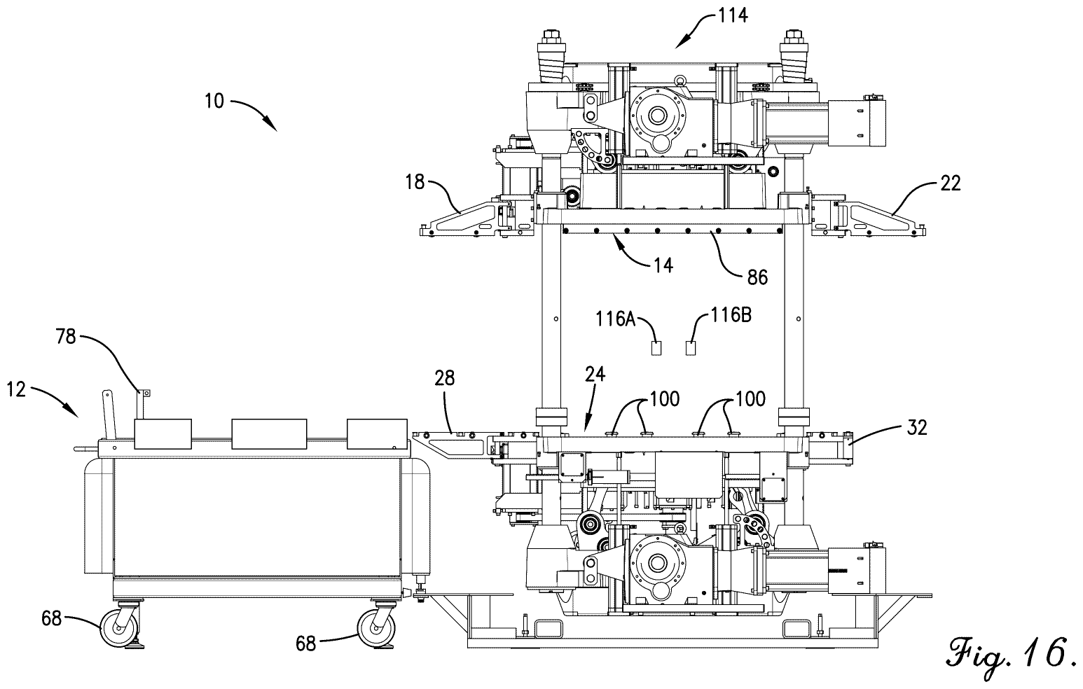

FIG. 16 is a side view of the press machine with the cart attached and without the top tool and the bottom tool;

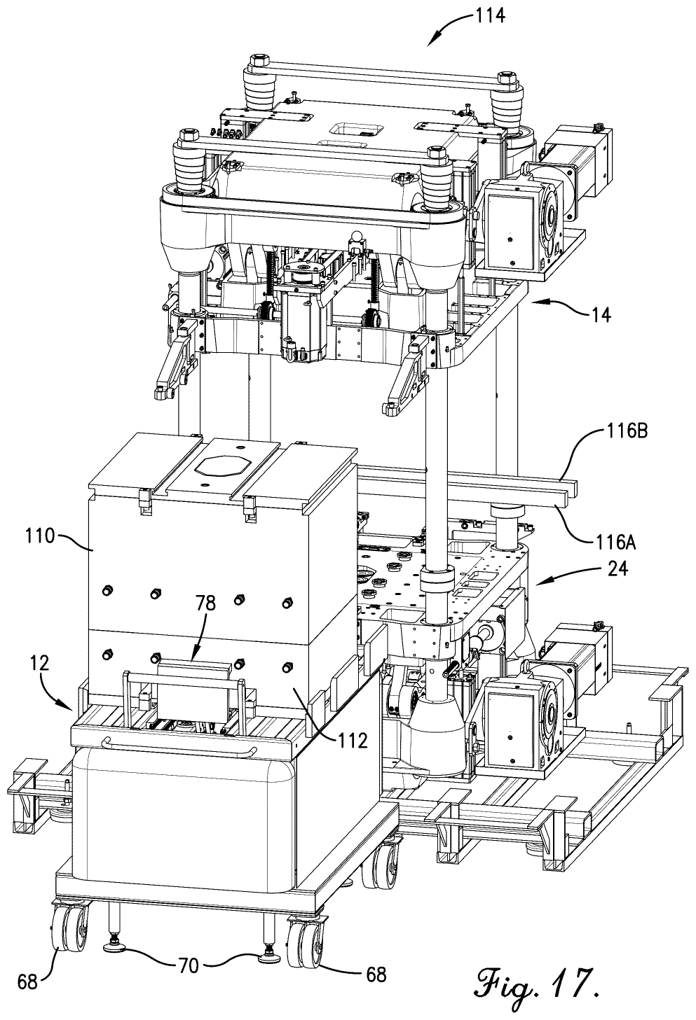

FIG. 17 is an upper perspective view of the press machine with the cart attached and with the top tool and the bottom tool loaded onto the cart;

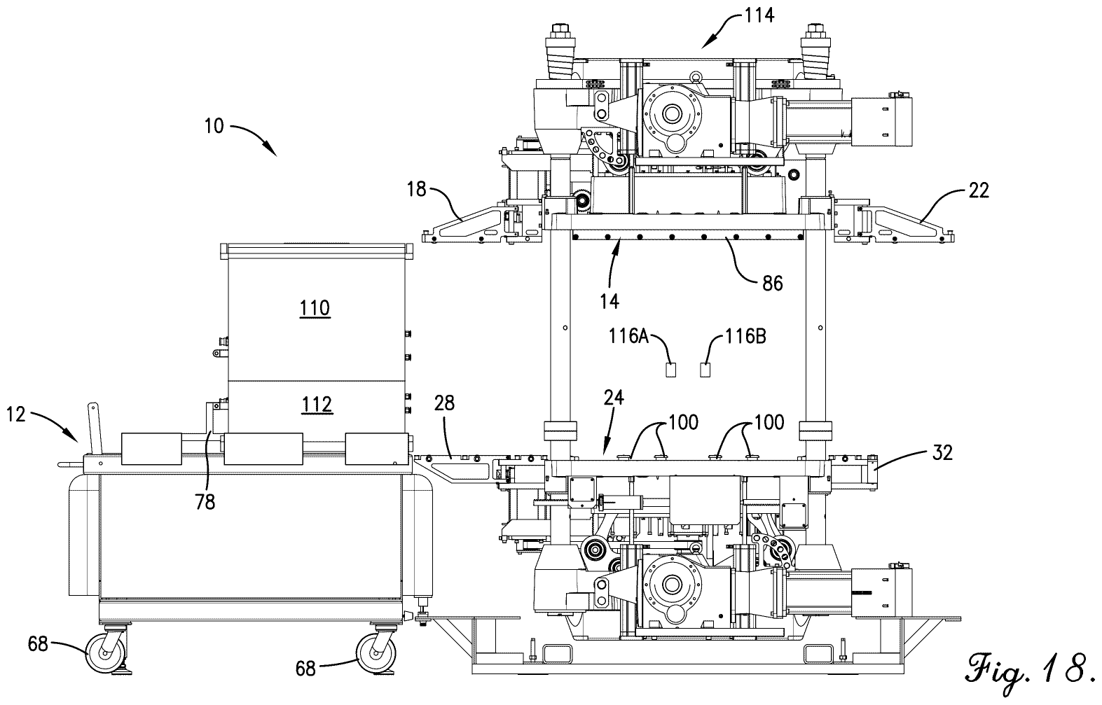

FIG. 18 is a side view of the press machine with the cart attached and with the top tool and the bottom tool loaded onto the cart;

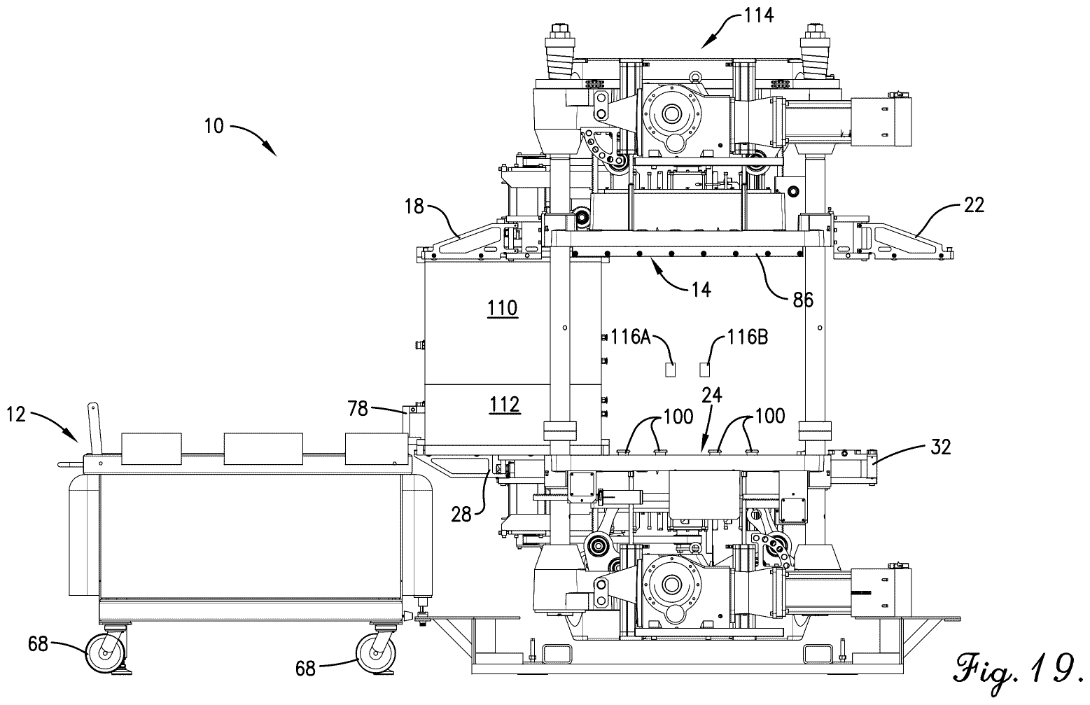

FIG. 19 is a side view of the press machine with the cart attached and with the top tool and the bottom tool moved by a first distance from the cart to the press machine;

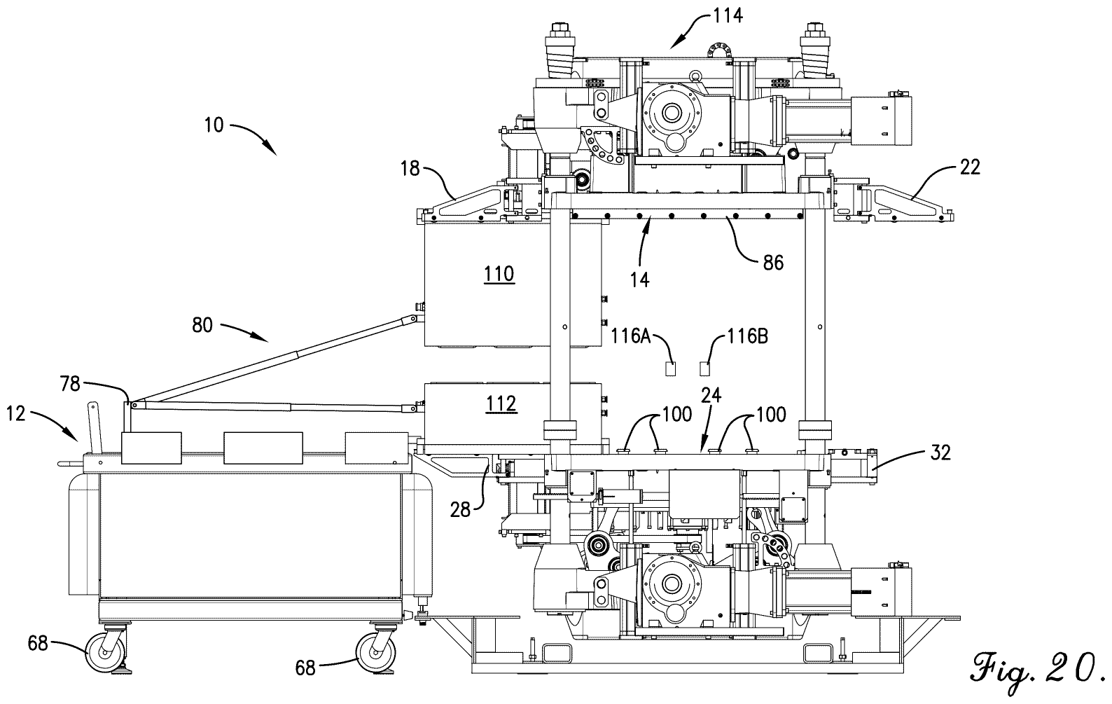

FIG. 20 is a side view of the press machine with the cart attached and with the upper platen and the top tool having been raised and the lower platen and the bottom tool having been lowered;

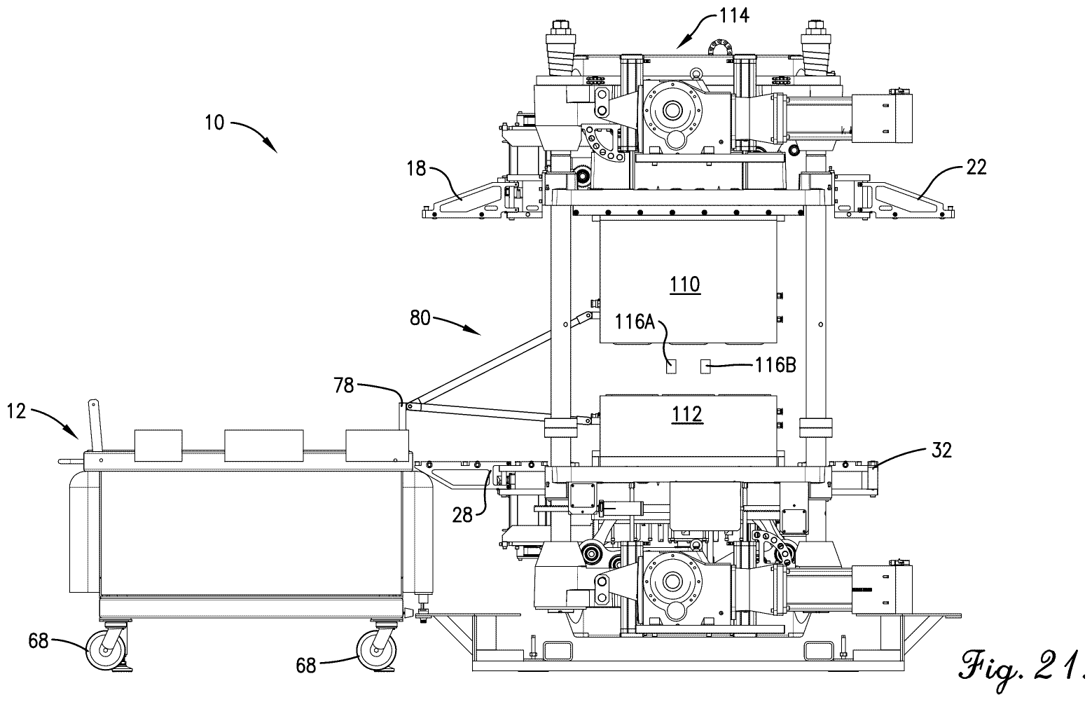

FIG. 21 is a side view of the press machine with the cart attached and with the top tool and the bottom tool moved by a second distance to a stop on the lower platen;

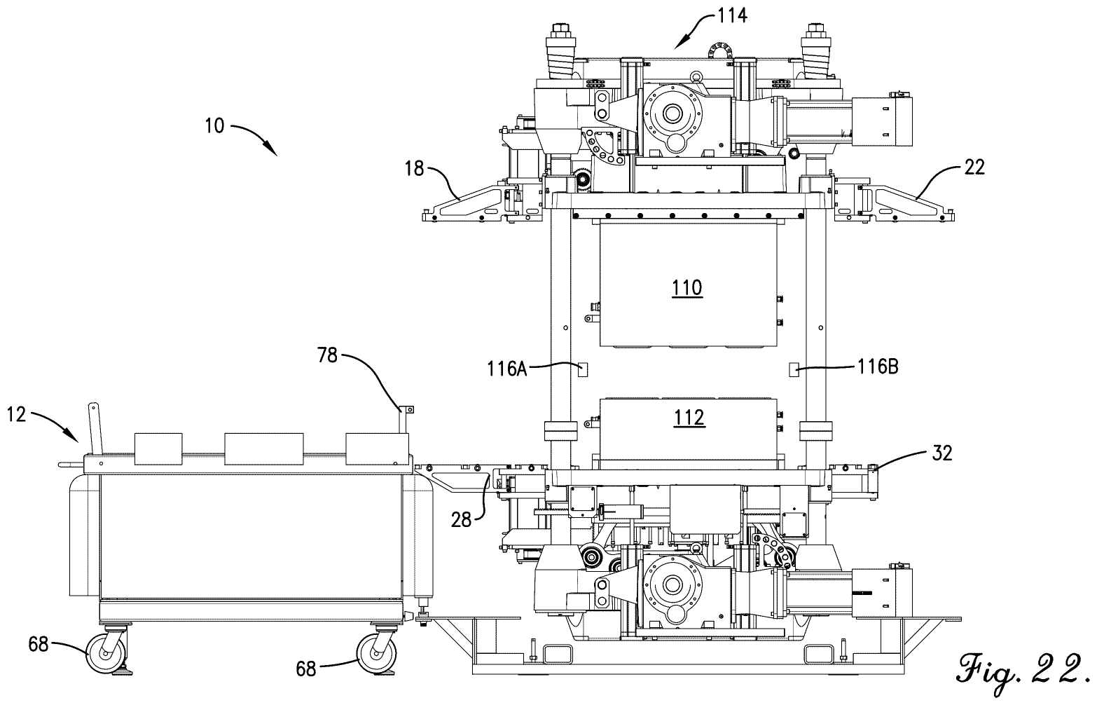

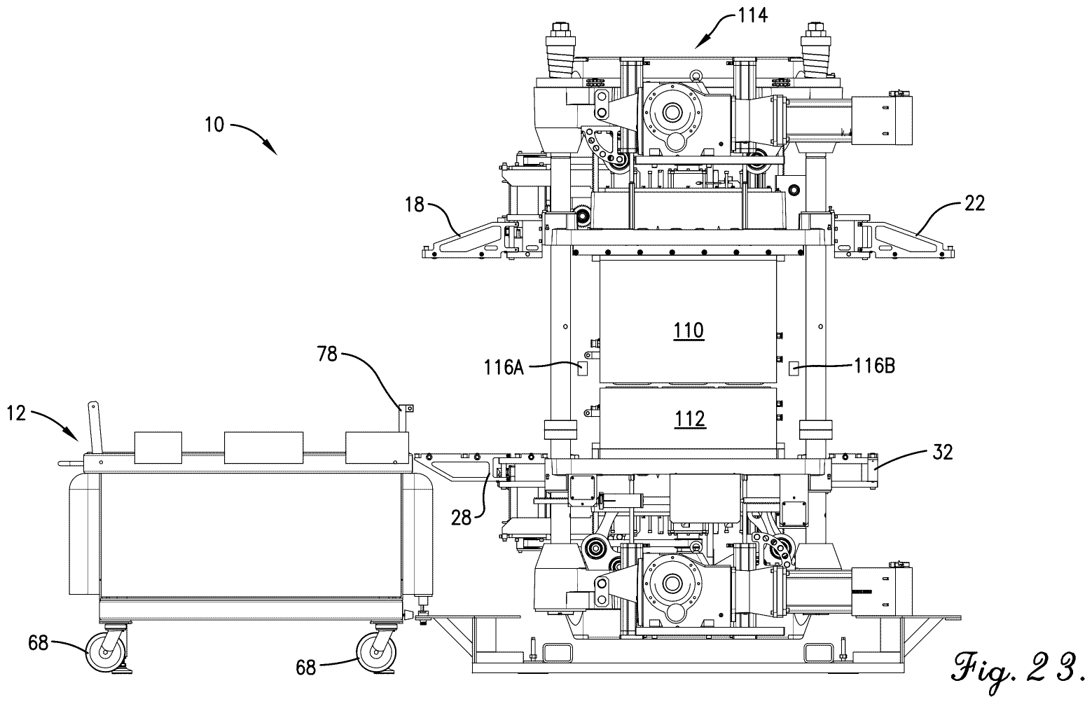

FIG. 22 is a side view of the press machine with the cart attached and with the top tool and the bottom tool being separated with first and second transport rails being spaced apart;

FIG. 23 is a side view of the press machine with the cart removed and with the upper platen and the top tool having been lowered and the lower platen and the bottom tool having been raised;

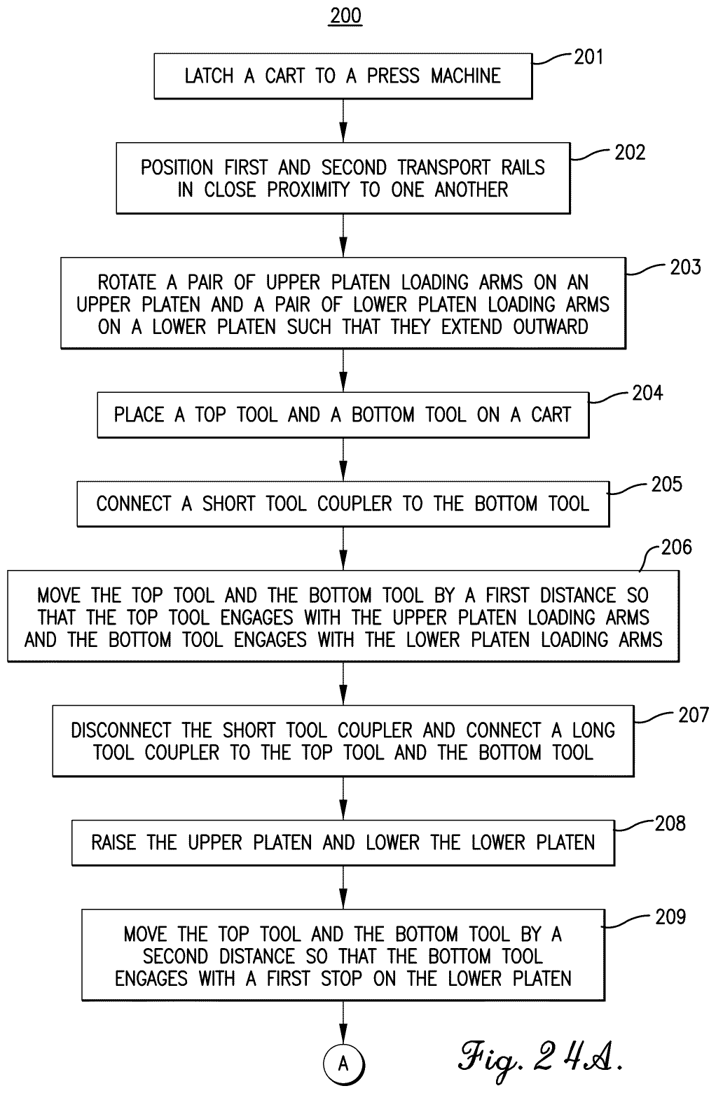

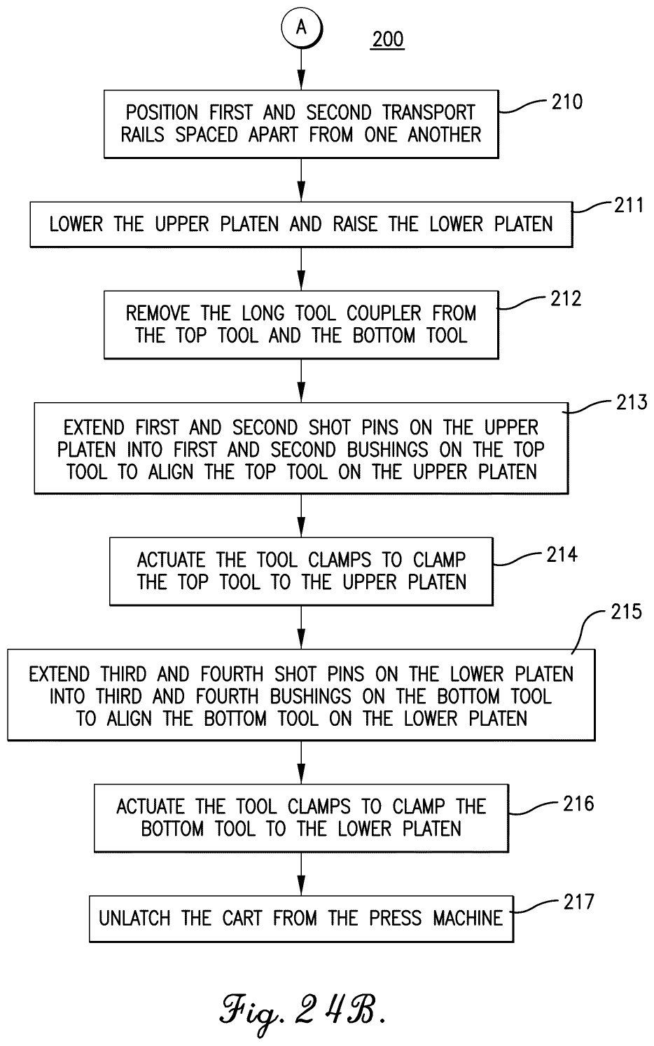

FIGS. 24A and 24B includes a listing of at least a portion of the steps of a method for loading a top tool and a bottom tool in a press machine; and

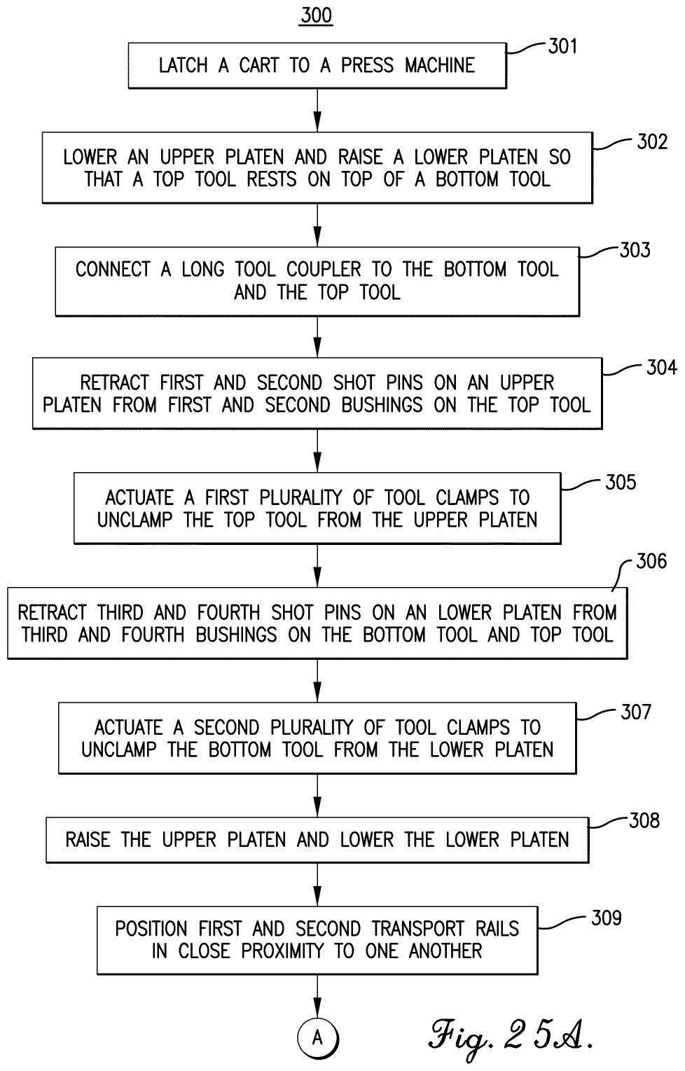

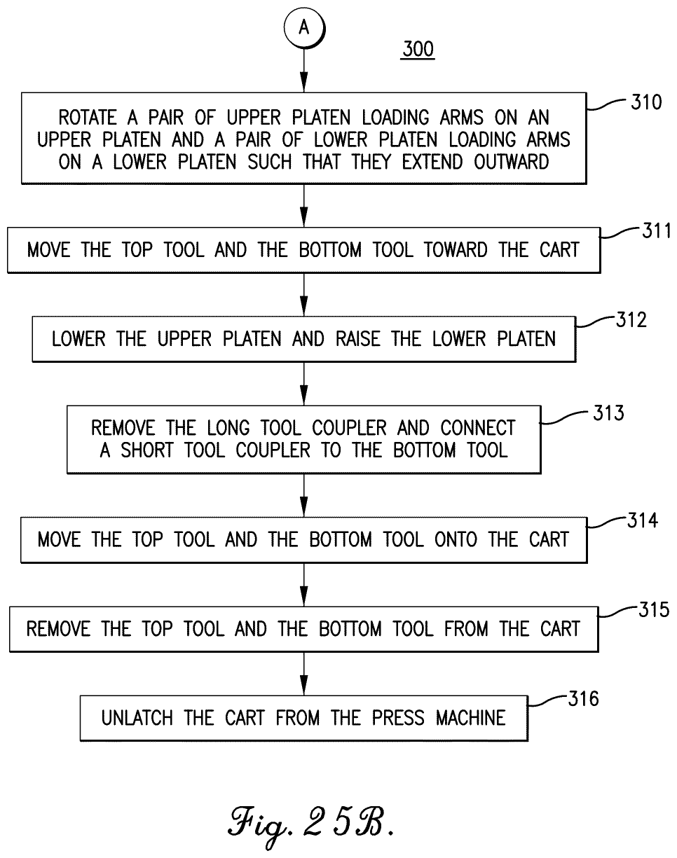

FIGS. 25A and 25B includes a listing of at least a portion of the steps of a method for unloading a top tool and a bottom tool in a press machine.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

Relational and/or directional terms, such as “above”, “below”, “up”, “upper”, “upward”, “down”, “lower”, “downward”, “top”, “bottom”, “outer”, “inner”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. However, embodiments of the technology in practice may be positioned and oriented in other ways or move in other directions. Therefore, the terms do not limit the scope of the current technology.

A system 10, constructed in accordance with various embodiments of the current invention, for changing a top tool 110 and a bottom tool 112 in a press machine 114 is shown in FIG. 1. The system 10 broadly comprises a cart 12 and components of the press machine 114 including an upper platen 14, a plurality of upper platen loading arms 16, 18, 20, 22, a lower platen 24, and a plurality of lower platen loading arms 26, 28, 30, 32. The press machine 114 further comprises a pair of transport rails 116A, 116B. The system 10 allows for the tools 110, 112 to be loaded and unloaded from either side (front or rear) of the press machine 114.

The press machine 114, as shown in FIGS. 1, 8, 9, 11, and 13-23, generally provides a pressing operation, that is, applying pressure, to a blank such as paper or plastic film or sheet in order to shape, score, fold, cut, and so forth, the blank during the production of a product, such as a plate or covered container. The press machine 114 may be positioned in and operate as one of a plurality of machines, components, or stations in a forming or thermoforming system, such as the system described in U.S. patent application Ser. No. 18/769,869, titled “METHODS AND SYSTEMS FOR PRODUCING PRESSWARE”, filed Jul. 11, 2024, which is incorporated by reference in the current patent application, except where its subject matter is inconsistent with the teachings of the current patent application.

The top tool 110 performs shaping, scoring, folding, cutting, or the like on an upper surface or aspect of the blank during production. The top tool 110 may include nearly any type of tool components to perform the operations listed. Exemplary embodiments of the top tool 110, as shown in FIGS. 4 and 5, include an upper surface, a lower surface, a left side surface, a right side surface, a front surface, and a back surface coupled to one another to form a generally rectangular cuboid. The top tool 110 also includes a top plate 34 which has first and second T-slots 36, 38 positioned on an upper surface thereof and spaced apart from one another—extending from a front of the top tool 110 to a back of the top tool 110. The upper surface of the top plate 34 also has first and second bushings 40, 42 that are configured to receive a successive one of a pair of shot pins 44, 46 from the upper platen 14 of the press machine 114. The top tool 110 further includes a left roller slot 48 positioned along the left surface and a right roller slot 50 positioned along the right surface. The front surface and the back surface may include connectors and/or fittings that connect to other press machine or thermoforming system components and are utilized during press operations. The front surface and the back surface may further include connectors and/or fittings that are utilized during loading and unloading of the top tool 110.

The bottom tool 112 performs shaping, scoring, folding, cutting, or the like on a lower surface or aspect of the blank during production. The bottom tool 112 may include nearly any type of tool components to perform the operations listed. The bottom tool 112, as shown in FIGS. 6 and 7, includes a bottom plate 52 which has third and fourth T-slots 54, 56 positioned on a lower surface thereof and spaced apart from one another-extending from a front of the bottom tool 112 to a back of the bottom tool 112. The lower surface of the bottom plate 52 also has third and fourth bushings 58, 60 that are configured to receive a successive one of a pair of shot pins 62, 64 from the lower platen 24 of the press machine 114. The front surface and the back surface may include connectors and/or fittings that connect to other press machine or thermoforming system components and are utilized during press operations. The front surface and the back surface may further include connectors and/or fittings that are utilized during loading and unloading of the bottom tool 112.

The transport rails 116A, 116B, as shown in FIGS. 1 and 13-23, provide transportation of material, such as plastic film, or components as the material or components pass from one machine to another machine along the production line. Each rail 116A, 116B is elongated with at least three connected side walls that surround a chain or linkage that couples to the material or components in order to move the material or components. The rails 116A, 116B are also configured, or driven, to come together or separate along a horizontal plane from the front of the press machine 114 to the back of the press machine 114. The coming together and separating is required during loading and unloading of the top tool 110 and the bottom tool 112.

The cart 12 generally provides temporary support of the tools 110, 112 during loading and unloading of the top tool 110 and the bottom tool 112 into and out of the press machine 114. The cart 12, as shown in FIGS. 2 and 3, includes a base 66, four wheels 68, four feet 70, an upper frame 72, a latch assembly 74, and a conveyor mechanism 76. The cart 12 also includes a left side wall, a right side wall, a front wall, and a back wall. The base 66 has a generally rectangular shape formed by four frame members. The wheels 68 are attached to the base 66 with a successive one of the wheels 68 positioned at each corner of the base 66. The feet 70 are coupled to a mechanism that allows the feet 70 to extend from, and retract into, the base 66 with each foot 70 positioned in proximity to a successive one of the wheels 68. The feet 70 provide stability to the cart 12 when they are extended during loading and unloading of the tools 110, 112, and allow the cart 12 to move when they are retracted. The left side wall, the right side wall, the front wall, and the back wall are connected to one another and each is connected to the base 66. The upper frame 72 has a generally rectangular shape formed by four orthogonally connected members, which also define the boundaries of an upper section of the cart 12. The latch assembly 74 is positioned on the front wall and couples to either the front side or the rear side of the press machine 114 during loading and unloading of the tools 110, 112 to maintain a position of the cart 12. Exemplary embodiments of the latch assembly 74 are driven by the mechanism that raises and lowers the feet 70 and include first and second plunger-type rods that extend to couple to the press machine 114 and retract to decouple from the press machine 114. There is one single mechanism that activates pins of the latch assembly 74 up and down, and at the same time places the four feet 70 on the ground to lift the cart 12 off its wheels 68, preventing it from rolling. The manual lever to activate the mechanism is situated in a way that neither the top tool 110 nor the bottom tool 112 can be loaded onto the cart 12 unless it is supported by the feet 70. The conveyor mechanism 76 is positioned on the upper section of the cart 12 and is utilized during loading and unloading of the tools 110, 112 to move the tools 110, 112 from the cart 12 to the press machine 114 and vice versa. The conveyor mechanism 76 includes left and right rails with chain-linked rungs positioned therebetween. The cart 12 further includes a crank handle coupled to the conveyor mechanism 76. Turning the crank handle moves the rungs back and forth along the rails. The system 10 further includes a short tool coupler 78 and a long tool coupler 80. The short tool coupler 78 includes an elongated upright block which is connected to the conveyor mechanism 76 and moves forward and backward when the conveyor mechanism 76 is activated (by turning the crank handle). The short tool coupler 78 connects to the bottom tool 112. The long tool coupler 80 includes first and second telescopic arms that are rotatably connected to a hinge. The hinge removably connects to the short tool coupler 78, the free end of the first arm removably connects to the bottom tool 112, and the free end of the second arm removably connects to the top tool 110. The long tool coupler 80 is utilized (i.e., connected to the short tool coupler 78, the top tool 110, and the bottom tool 112) to move the top tool 110 and the bottom tool 112 from the platens 14, 24 to the loading arms 16, 18, 26, 28 and vice versa. The short tool coupler 78 is utilized (i.e., connected to the bottom tool 112) to move the top tool 110 and the bottom tool 112 from the loading arms 16, 18, 26, 28 to the cart 12 and vice versa.

The long tool coupler 80 connect the short tool coupler 78 to the top tool 110 and the bottom tool 112 to ensure that the top tool 110 is placed back on the bottom tool 112 in the same position and/or location as when the two tools 110, 112 are separated.

The upper platen 14 retains the top tool 110 during operation of the press machine 114. The upper platen 14, as shown in FIGS. 9 and 10, includes an upper surface, a lower surface, a left side surface, a right side surface, a front surface, and a back surface coupled to one another to form a generally rectangular cuboid. The upper platen 14 includes a plurality of top tool clamps 82, first and second shot pins 44, 46, and left and right side strips 84, 86. The top tool clamps 82 are T-knob shaped, having a cylindrical body and a circumferential flange along a top edge. The top tool clamps 82 are positioned in two spaced apart rows on the lower surface, with four top tool clamps 82 in each row as an exemplary configuration. A first row of the top tool clamps 82 is aligned with, and fits into, the first T-slot 36 of the top tool 110 and a second row of the top tool clamps 82 is aligned with, and fits into, the second T-slot 38. The top tool clamps 82 are actuated to extend outward from the lower surface so that the flanges are at a first height during loading and unloading of the top tool 110 and retract inward in the lower surface so that the flanges are at a second height to retain the top tool 110 during operation of the press machine 114. The first and second shot pins 44, 46, as shown in FIG. 10, are each roughly cylindrical shaped and have a tapered tip. The first and second shot pins 44, 46 are spaced apart from one another and positioned in openings along a center line on the lower surface. The first and second shot pins 44, 46 are actuated to extend outward from the lower surface and into the first and second bushings 40, 42, respectively, in order to properly align the top tool 110 during loading and operation of the top tool 110. The first and second shot pins 44, 46 are actuated to retract inward to the lower surface during unloading of the top tool 110. The left side strip 84 is positioned near a left edge of the lower surface, and the right side strip 86 is positioned near a right edge of the lower surface. Each side strip 84, 86 extends downward from the lower surface. The left side strip 84 includes a first plurality of interior facing rollers 88 which fit into the left roller slot 48 of the top tool 110. The right side strip 86 includes a second plurality of interior facing rollers 90 which fit into the right roller slot 50 of the top tool 110.

Each upper platen loading arm 16, 18, 20, 22, as shown in FIGS. 8-11, has a body with a generally triangular shape, although other shapes such as rectangular are possible. A first upper platen loading arm 16 is positioned on a left side of the front surface of the upper platen 14 and a second upper platen loading arm 18 is positioned on a right side of the front surface of the upper platen 14. A third upper platen loading arm 20 is positioned on a right side of the rear surface of the upper platen 14 and a fourth upper platen loading arm 22 is positioned on a left side of the rear surface of the upper platen 14. The first upper platen loading arm 16 and the third upper platen loading arm 20 each generally align with the left side strip 84, as shown in FIG. 10. The second upper platen loading arm 18 and the fourth upper platen loading arm 22 generally align with the right side strip 86, as shown in FIG. 10.

The first upper platen loading arm 16 includes a third plurality of interior facing rollers 92. The second upper platen loading arm 18 includes a fourth plurality of interior facing rollers 94. The third upper platen loading arm 20 includes a fifth plurality of interior facing rollers 96. The fourth upper platen loading arm 22 includes a sixth plurality of interior facing rollers 98. The rollers 92 and the rollers 96 each align with the rollers 88 and each fits into the left roller slot 48 of the top tool 110. The rollers 94 and the rollers 98 each align with the rollers 90 and each fits into the right roller slot 50 of the top tool 110.

Furthermore, each upper platen loading arm 16, 18, 20, 22 is configured to rotate through a range from approximately 0 degrees to approximately 180 degrees. In a first rotational position, each upper platen loading arm 16, 18, 20, 22 extends outward (approximately 90 degrees) from the upper platen 14 during loading and unloading of the top tool 110. In a second rotational position, each upper platen loading arm 16, 18, 20, 22 is configured to rotate, or fold, sideways (approximately 0 degrees or approximately 180 degrees) toward a center of the front and back surfaces of the upper platen 14 during operation of the press machine 114.

The lower platen 24 retains the bottom tool 112 during operation of the press machine 114. The lower platen 24, as shown in FIGS. 11 and 12, includes an upper surface, a lower surface, a left side surface, a right side surface, a front surface, and a back surface coupled to one another to form a generally rectangular cuboid. The lower platen 24 includes a plurality of bottom tool clamps 100 and third and fourth shot pins 62, 64. The bottom tool clamps 100, similar to the top tool clamps 82, are T-knob shaped, having a cylindrical body and a circumferential flange along a top edge. The bottom tool clamps 100 are positioned in two spaced apart rows on the upper surface, with four bottom tool clamps 100 in each row as an exemplary configuration. A first row of the bottom tool clamps 100 is aligned with, and fits into, the third T-slot 40 of the bottom tool 112 and a second row of the bottom tool clamps 100 is aligned with, and fits into, the fourth T-slot 42. The bottom tool clamps 100 are actuated to extend outward from the upper surface so that the flanges are at a first height during loading and unloading of the bottom tool 112 and retract inward in the lower surface so that the flanges are at a second height to retain the bottom tool 112 during operation of the press machine 114. The third and fourth shot pins 62, 64, as shown in FIG. 12, are each roughly cylindrical shaped and have a tapered tip. The third and fourth shot pins 62, 64 are spaced apart from one another and positioned in openings along a center line on the upper surface. The third and fourth shot pins 62, 64 are actuated to extend outward from the upper surface and into the third and fourth bushings 58, 60, respectively, in order to properly align the bottom tool 112 during loading and operation of the bottom tool 112. The third and fourth shot pins 62, 64 are actuated to retract inward to the upper surface during unloading of the bottom tool 112. In addition, the lower platen 24 includes a first stop 101A and a second stop 101B each positioned at a boundary where the bottom tool 112 should stop when it is being loaded from either the front side or the back side. Each of the first stop 101A and the second stop 101B include a block that may extend from, and retract into, the upper surface of the lower platen 24.

Each lower platen loading arm 26, 28, 30, 32, as shown in FIGS. 8, 9, 11, and 12, has a body with a generally triangular shape, although other shapes such as rectangular are possible. A first lower platen loading arm 26 is positioned on a left side of the front surface of the lower platen 24, and a second lower platen loading arm 28 is positioned on a right side of the front surface of the lower platen 24. A third lower platen loading arm 30 is positioned on a right side of the rear surface of the lower platen 24, and a fourth lower platen loading arm 32 is positioned on a left side of the rear surface of the lower platen 24. The first lower platen loading arm 26 and the third lower platen loading arm 30 each generally align with the first row of bottom tool clamps 100, as shown in FIG. 12. The second lower platen loading arm 28 and the fourth lower platen loading arm 32 each generally align with the second row of bottom tool clamps 100, as shown in FIG. 12. The first lower platen loading arm 26 has a first track that fits into the third T-slot 40 of the bottom tool 112. The second lower platen loading arm 28 has a second track that fits into the fourth T-slot 42 of the bottom tool 112. The third lower platen loading arm 30 has a third track that fits into the third T-slot 40 of the bottom tool 112. The fourth lower platen loading arm 32 has a fourth track that fits into the fourth T-slot 42 of the bottom tool 112.

Each lower platen loading arm 26, 28, 30, 32 is configured to rotate through a range from approximately 0 degrees to approximately 180 degrees. In a first rotational position, each lower platen loading arm 26, 28, 30, 32 extends outward (approximately 90 degrees) from the lower platen 24 during loading and unloading of the bottom tool 112. In a second rotational position, each lower platen loading arm 26, 28, 30, 32 is configured to rotate, or fold, sideways (approximately 0 degrees or approximately 180 degrees) toward an outer edge of the front and back surfaces of the lower platen 24 during operation of the press machine 114. Referring to FIG. 12, the first lower platen loading arm 26 and the second lower platen loading arm 28 each are extended outward, and the third lower platen loading arm 30 and the fourth lower platen loading arm 32 each are folded sideways.

The top tool clamps 82 may each be actuated by a successive one of a plurality of pneumatic cylinders that is coupled to the tool clamp 82. Thus, each pneumatic cylinder can move its associated tool clamp 82 between the first height and the second height. Alternatively, the top tool clamps 82 may be actuated as a group by at least one pneumatic cylinder coupled to the top tool clamps 82 and able to move the top tool clamps 82 between the first height and the second height. The bottom tool clamps 100 may each be actuated by a successive one of a plurality of pneumatic cylinders that is coupled to the tool clamp 100. Thus, each pneumatic cylinder can move its associated tool clamp 100 between the first height and the second height. Alternatively, the bottom tool clamps 100 may be actuated as a group by at least one pneumatic cylinder coupled to the bottom tool clamps 100 and able to move the bottom tool clamps 100 between the first height and the second height.

The first and second shot pins 44, 46 may each be actuated by a successive one of a plurality of pneumatic cylinders that is coupled to the shot pin 44, 46. Thus, each pneumatic cylinder can move its associated shot pin 44, 46 outward and inward. Alternatively, the first and second shot pins 44, 46 may be actuated as a group by at least one pneumatic cylinder coupled to the shot pins 44, 46 and able to move the shot pins 44, 46 outward and inward. The third and fourth shot pins 62, 64 may each be actuated by a successive one of a plurality of pneumatic cylinders that is coupled to the shot pin 62, 64. Thus, each pneumatic cylinder can move its associated shot pin 62, 64 outward and inward. Alternatively, the third and fourth shot pins 62, 64 may be actuated as a group by at least one pneumatic cylinder coupled to the shot pins 62, 64 and able to move the shot pins 62, 64 outward and inward.

The system 10 may operate as follows in order to load the top tool 110 and the bottom tool 112 into the press machine 114. Referring to FIGS. 13 and 14, the press machine 114 waits for the top tool 110 and the bottom tool 112 to be loaded. The upper platen loading arms 16, 18, 20, 22 and the lower platen loading arms 26, 28, 30, 32 are rotated sideways. The top tool clamps 82 of the upper platen 14 and the bottom tool clamps 100 of the lower platen 24 are each adjusted to the first height in order to receive the tools 110, 112 before clamping. The first and second shot pins 44, 46 are retracted into the upper platen 14. The third and fourth shot pins 62, 64 are retracted into the lower platen 24. The transport rails 116A, 116B are positioned in close proximity to one another. Referring to FIGS. 15 and 16, the cart 12 is positioned facing the front of the press machine 114, and the latch assembly 74 is coupled to the press machine 114. In addition, the feet 70 are lowered to contact a floor so that the cart 12 maintains its position. (The cart 12 may alternatively be positioned facing the rear of the press machine 114.) Referring to FIG. 1, the top tool 110 and the bottom tool 112 are retrieved from their storage places and loaded onto the cart 12. The top tool 110 and the bottom tool 112 may be retrieved using a fork lift. The top tool 110 is typically positioned on top of the bottom tool 112.

While the top tool 110 and the bottom tool 112 are positioned on the cart 12, a first height of the lower edge of the bottom tool 112 and a second height of the upper edge of the top tool 110 are measured and recorded. The heights indicate the general vertical position of the upper platen 14 in relation to the lower platen 24 during loading and unloading of the top tool 110 and the bottom tool 112. This is typically a one-time activity for each tool 110, 112 for the first time the tool is used. In addition, the upper platen loading arms 16, 18, 20, 22 and the lower platen loading arms 26, 28, 30, 32 on the side where the loading or unloading of the tools 110, 112 takes place are rotated so that they extend outward.

The upper platen 14 is positioned vertically (by raising or lowering the upper platen 14) to the second height (the “closed” position) so that the rollers 88 of the left side strip 84 and the rollers 92 of the first upper platen loading arm 16 are aligned with the left roller slot 48 of the top tool 110 and the rollers 90 of the right side strip 86 and the rollers 94 of the second upper platen loading arm 18 are aligned with the right roller slot 50. The lower platen 24 is positioned vertically (by raising or lowering the lower platen 24) to the first height (the “closed” position) so that the first lower platen loading arm 26 is aligned the first T-slot 36 of the bottom tool 112 and the second lower platen loading arm 28 is aligned with the second T-slot 38. The lowering of the upper platen 14 and the raising of the lower platen 24 may be referred to as “closing the press”.

Referring to FIGS. 17 and 18, the short tool coupler 78 is connected to the bottom tool 112. The crank handle is turned so that the short tool coupler 78 pushes the bottom tool 112 (along with the top tool 110) forward towards the press machine 114. The rollers 88 of the left side strip 84 and the rollers 92 of the first upper platen loading arm 16 engage with the left roller slot 48 of the top tool 110 and the rollers 90 of the right side strip 86 and the rollers 94 of the second upper platen loading arm 18 engage with the right roller slot 50.

Referring to FIG. 19, the top tool 110 and the bottom tool 112 have been advanced forward by the conveyor mechanism 76 and the short tool coupler 78 so that they are no longer positioned on the cart 12. The short tool coupler 78 is disconnected from the bottom tool 112 and moved backward on the conveyor mechanism 76. The long tool coupler 80 is then connected to the short tool coupler 78, the top tool 110, and the bottom tool 112. Referring to FIG. 20, the upper platen 14 is raised and the lower platen 24 is lowered, in a process referred to as “opening the press”, in order for the top tool 110 and the bottom tool 112 to avoid the transport rails 116A, 116B as the tools 110, 112 are moved forward. The crank handle is turned so that the short tool coupler 78 and the long tool coupler 80 push the top tool 110 from the loading arms 16, 18 onto the upper platen 14 and the bottom tool 112 from the loading arms 26, 28 onto the lower platen 24.

As the top tool 110 and the bottom tool 112 are advanced farther onto the press machine 114, the first T-slot 36 of the bottom tool 112 engages with the first row of the top tool clamps 82, and the second T-slot 38 of the bottom tool 112 engages with the second row of the top tool clamps 82. The third T-slot 40 of the top tool 110 engages with the first row of the bottom tool clamps 100, and the fourth T-slot 42 of the top tool 110 engages with the second row of the bottom tool clamps 100. The left roller slot 48 engages with the rollers 88 of the upper platen 14, and the right roller slot 50 engages with the rollers 90 of the upper platen 14.

The short tool coupler 78 and the long tool coupler 80 advance the top tool 110 and the bottom tool 112 until the bottom tool 112 encounters the first stop 101A on the lower platen 24. The first and second shot pins 44, 46 are extended into the first and second bushings 40, 42, respectively, in order to align the top tool 110 in its proper location. The third and fourth shot pins 62, 64 are extended into the third and fourth bushings 58, 60, respectively, in order to align the bottom tool 112 in its proper location. The top tool clamps 82 of the upper platen 14 and the bottom tool clamps 100 of the lower platen 24 are each actuated to the second height to clamp the top tool 110 and the bottom tool 112, respectively, into position. The upper platen loading arms 16, 18, 20, 22 and the lower platen loading arms 26, 28, 30, 32, at least on the front side, are rotated sideways. The transport rails 116A, 116B are positioned spaced apart from one another. The upper platen 14 and the top tool 110 are lowered. The lower platen 24 and the bottom tool 112 are raised. The long tool coupler 80 is removed. The cart 12 is unlatched from the press machine 114, and the feet 70 are raised. The cart 12 is then moved to another location away from the press machine 114. The press machine 114 may engage in normal operation. Some of the actions described could occur in a different order or even concurrently.

The top tool 110 and the bottom tool 112 may be unloaded from the press machine 114 as follows. The press machine 114 may be in an idle state as shown in FIG. 23. The cart 12 is moved to one side (front or back) of the press machine 114, the latch assembly 74 is coupled to the press machine 114, and the feet 70 are lowered to contact the floor so that the cart 12 maintains its position, as shown in FIG. 22. The long tool coupler 80 is connected to the short tool coupler 78 and the top and bottom tools 110, 112. The top tool clamps 82 of the upper platen 14 and the bottom tool clamps 100 of the lower platen 24 are each actuated to the first height to unclamp the top tool 110 and the bottom tool 112, respectively. The first and second shot pins 44, 46 are retracted from the first and second bushings 40, 42, respectively. The third and fourth shot pins 62, 64 are retracted from the third and fourth bushings 58, 60, respectively. The upper platen loading arms 16, 18, 20, 22 and the lower platen loading arms 26, 28, 30, 32, at least on the left side, are rotated so that they extend outward. Referring to FIG. 22, the upper platen 14 is raised and the lower platen 24 is lowered. Referring to FIG. 21, the transport rails 116A, 116B are positioned in close proximity to one another.

The crank handle is turned so that the short tool coupler 78 and the long tool coupler 80 pull the top tool 110 and the bottom tool 112 toward the cart 12. When the top tool 110 and the bottom tool 112 get near the cart 12 and the tools 110, 112 have moved away from the transport rails 116A, 116B, as shown in FIG. 20, the upper platen 14 is lowered and the lower platen 24 is raised so that the top tool 110 rests on the bottom tool 112, as shown in FIG. 19. In addition, the long tool coupler 80 is removed. The short tool coupler 78 is moved forward and connected to the bottom tool 112. The crank handle is turned so that the short tool coupler 78 pulls the top tool 110 and the bottom tool 112 from the press machine 114 and the loading arms 16, 18, 26, 28 onto the cart 12, as shown in FIGS. 17 and 18. When the tools 110, 112 are fully on the cart 12, the short tool coupler 78 is disconnected from the bottom tool 112. The top tool 110 and the bottom tool 112 are removed using a fork lift and returned to a storage location. The upper platen loading arms 16, 18, 20, 22 and the lower platen loading arms 26, 28, 30, 32, at least on the front side, are rotated sideways. The cart 12 is unlatched from the press machine 114, and the feet 70 are raised. The cart 12 is then moved to another location away from the press machine 114.

FIGS. 24A and 24B depicts a listing of at least a portion of the steps of an exemplary method 200 for loading a top tool 110 and a bottom tool 112 into a press machine 114. Variations to the steps may be performed. The steps may be performed in the order shown in FIG. 24A and 24B, or they may be performed in a different order. Furthermore, some steps may be performed concurrently as opposed to sequentially. In addition, some steps may be optional or may not be performed.

Referring to step 201 and FIGS. 15 and 16, a cart 12 is latched to a press machine 114. The press machine 114, as shown in FIGS. 1, 8, 9, 11, and 13-23, generally provides a pressing operation, that is, applying pressure, to a blank such as paper or plastic film or sheet in order to shape, score, fold, cut, and so forth, the blank during the production of a product, such as a plate or covered container. The cart 12 generally provides temporary support of the tools 110, 112 during loading and unloading of the top tool 110 and the bottom tool 112 into and out of the press machine 114 and its details are described above. The cart 12 includes a latch assembly 74 which is positioned on a front wall and couples to the press machine 114 during loading and unloading of the tools 110, 112 to maintain a position of the cart 12.

Referring to step 202, first and second transport rails 116A, 116B are positioned in close proximity to one another. The transport rails 116A, 116B provide transportation of material, such as plastic film, or components as the material or components pass from one machine to another machine along the production line.

Referring to step 203, a pair of upper platen loading arms 16, 18, 20, 22 on an upper platen 14 and a pair of lower platen loading arms 26, 28, 30, 32 on a lower platen 24 are rotated such that they extend outward. The upper platen 14 retains the top tool 110 during operation of the press machine 114 and its details are described above. The upper platen loading arms 16, 18, 20, 22 include a first upper platen loading arm 16 positioned on a left side of the front surface of the upper platen 14, a second upper platen loading arm 18 positioned on a right side of the front surface of the upper platen 14, a third upper platen loading arm 20 positioned on a right side of the rear surface of the upper platen 14, and a fourth upper platen loading arm 22 positioned on a left side of the rear surface of the upper platen 14.

The lower platen 24 retains the bottom tool 112 during operation of the press machine 114 and its details are described above. The lower platen loading arms 26, 28, 30, 32 include a first lower platen loading arm 26 positioned on a left side of the front surface of the lower platen 24, a second lower platen loading arm 28 positioned on a right side of the front surface of the lower platen 24, a third lower platen loading arm 30 positioned on a right side of the rear surface of the lower platen 24, and a fourth lower platen loading arm 32 positioned on a left side of the rear surface of the lower platen 24.

The upper platen 14 is lowered and the lower platen 24 is raised. The upper platen 14 is positioned vertically (typically by lowering the upper platen 14) to the second height (discussed above) so that the rollers 88 of the left side strip 84 and the rollers 92 of the first upper platen loading arm 16 are aligned with the left roller slot 48 of the top tool 110 and the rollers 90 of the right side strip 86 and the rollers 94 of the second upper platen loading arm 18 are aligned with the right roller slot 50. The upper platen 14 may be positioned vertically by a drive motor coupled to a toggle system that moves the upper platen 14 in a vertical direction. The lower platen 24 is positioned vertically (typically by raising the lower platen 24) to the first height (discussed above) so that the first lower platen loading arm 26 is aligned the first T-slot 36 of the bottom tool 112 and the second lower platen loading arm 28 is aligned with the second T-slot 38.

Referring to step 204 and FIG. 1, the top tool 110 and the bottom tool 112 are placed onto a cart 12. The top tool 110 performs shaping, scoring, folding, cutting, or the like on an upper surface or aspect of the blank during production and its details are described above. The bottom tool 112 performs shaping, scoring, folding, cutting, or the like on a lower surface or aspect of the blank during production and its details are described above. The tools 110, 112 may be placed on the cart 12 using a fork lift.

Referring to step 205 and FIGS. 17 and 18, a short tool coupler 78 is connected to the bottom tool 112. The cart 12 includes a conveyor mechanism 76 positioned on the upper section of the cart 12 and utilized during loading and unloading of the tools 110, 112 to move the tools 110, 112 from the cart 12 to the press machine 114 and vice versa. The conveyor mechanism 76 includes left and right rails with chain-linked rungs positioned therebetween. The cart 12 further includes a crank handle coupled to the conveyor mechanism 76. Turning the crank handle moves the rungs back and forth along the rails. The short tool coupler 78 includes an elongated upright block which is connected to the conveyor mechanism 76 and moves forward and backward when the conveyor mechanism 76 is activated (by turning the crank handle).

Referring to step 206 and FIGS. 18 and 19, the top tool 110 and the bottom tool 112 are moved by a first distance so that the top tool 110 engages with the first and second upper platen loading arms 16, 18 and the bottom tool 112 engages with the first and second lower platen loading arms 16, 18. The top tool 110 and the bottom tool 112 are moved as a result of being pushed by the short tool coupler 78.

The top tool 110 includes a top plate 34 which has first and second T-slots 36, 38 positioned on an upper surface thereof and spaced apart from one another-extending from a front of the top tool 110 to a back of the top tool 110. The top tool 110 further includes a left roller slot 48 positioned along the left surface and a right roller slot 50 positioned along the right surface.

The bottom tool 112 includes a bottom plate 52 which has third and fourth T-slots 54, 56 positioned on a lower surface thereof and spaced apart from one another-extending from a front of the bottom tool 112 to a back of the bottom tool 112.

The short tool coupler 78 is attached to the conveyor mechanism 76 and the bottom tool 112. The conveyor mechanism 76 is engaged by turning the crank handle so that the top tool 110 and the bottom tool 112 are moved (i.e., pushed) by a first distance from the cart 12 to the press machine 114. Initially, the first T-slot 36 of the bottom tool 112 engages with the first lower platen loading arm 26, and the second T-slot 38 engages with the second lower platen loading arm 28. The left roller slot 48 engages with the rollers 92 of the first upper platen loading arm 16, and the right roller slot 50 engages with the rollers 94 of the second upper platen loading arm 18. The top tool 110 and the bottom tool 112 are advanced forward by the conveyor mechanism 76 and the short tool coupler 78 so that they are no longer positioned on the cart 12.

Referring to step 207 and FIG. 20, the short tool coupler 78 is disconnected from the bottom tool 112 and moved backward on the cart 12. The long tool coupler 80 is then connected to the short tool coupler 78 and the top and bottom tools 110, 112.

Referring to step 208 and FIG. 20, the upper platen 14 is raised and the lower platen 24 is lowered, which separates the tools 110, 112. The platens 14, 24 are spaced farther apart in order for the top tool 110 and the bottom tool 112 to avoid the transport rails 116A, 116B as the tools 110, 112 are moved forward.

Referring to step 209 and FIG. 21, the top tool 110 and the bottom tool 112 are moved (pushed by the conveyor mechanism 76, the short tool coupler 78, and the long tool coupler 80) to a second distance so that the bottom tool 112 encounters the first stop 101A on the lower platen 24. The top tool 110 engages with a plurality of top tool clamps 82 on the upper platen 14 and the bottom tool 112 engages with a plurality of bottom tool clamps 100 on the lower platen 24. The top tool clamps 82 are T-knob shaped, having a cylindrical body and a circumferential flange along a top edge. The top tool clamps 82 are positioned in two spaced apart rows on the lower surface, with four top tool clamps 82 in each row as an exemplary configuration. A first row of the top tool clamps 82 is aligned with, and fits into, the first T-slot 36 of the top tool 110 and a second row of the top tool clamps 82 is aligned with, and fits into, the second T-slot 38. The top tool clamps 82 are, or were previously, actuated to extend outward from the lower surface so that the flanges are at a first height during loading and unloading of the top tool 110. The bottom tool clamps 100, similar to the top tool clamps 82, are T-knob shaped, having a cylindrical body and a circumferential flange along a top edge. The bottom tool clamps 100 are positioned in two spaced apart rows on the upper surface, with four bottom tool clamps 100 in each row as an exemplary configuration. A first row of the bottom tool clamps 100 is aligned with, and fits into, the third T-slot 40 of the bottom tool 112 and a second row of the bottom tool clamps 100 is aligned with, and fits into, the fourth T-slot 42. The bottom tool clamps 100 are, or were previously, actuated to extend outward from the upper surface so that the flanges are at a first height during loading and unloading of the bottom tool 112.

Referring to step 210, the transport rails 116A, 116B are positioned spaced apart from one another.

Referring to step 211 and FIG. 20, the upper platen 14 is lowered and the lower platen 24 is raised, which brings the tools 110, 112 together.

Referring to step 212, the long tool coupler 80 is removed from the top tool 110 and the bottom tool 112.

Referring to step 213, first and second shot pins 44, 46 on the upper platen 14 are extended into first and second bushings 40, 42 on the top tool 110 to align the top tool 110 on the upper platen 14. The first and second shot pins 44, 46 are roughly cylindrical shaped and have a tapered tip. The first and second shot pins 44, 46 are spaced apart from one another and positioned in openings along a center line on the lower surface of the upper platen 14. The first and second shot pins 44, 46 are actuated to extend outward from the lower surface. The first and second bushings 40, 42 are positioned on an upper surface of the top tool 110.

Referring to step 214, the top tool clamps 82 are actuated to clamp the top tool 110 to the upper platen 14. The top tool clamps 82 are engaged or actuated to retract inward in the lower surface so that the flanges are at a second height, less than the first height, to retain the top tool 110 during operation of the press machine 114.

Referring to step 215, third and fourth shot pins 62, 64 on the lower platen 24 are extended into third and fourth bushings 58, 60 on the bottom tool 112 to align the bottom tool 112 on the lower platen 24. The third and fourth shot pins 62, 64 are roughly cylindrical shaped and have a tapered tip. The third and fourth shot pins 62, 64 are spaced apart from one another and positioned in openings along a center line on the upper surface. The third and fourth shot pins 62, 64 are actuated to extend outward from the upper surface. The third and fourth bushings 58, 60 are positioned on a lower surface of the bottom tool 112.

Referring to step 216, the bottom tool clamps 100 are engaged or actuated to clamp the bottom tool 112 to the lower platen 24. The bottom tool clamps 100 are actuated to retract inward in the lower surface so that the flanges are at a second height to retain the bottom tool 112 during operation of the press machine 114.

Referring to step 217 and FIG. 23, the cart 12 is unlatched from the press machine 114, and the feet 70 are raised. The cart 12 is then moved to another location away from the press machine 114. The press machine 114 may engage in normal operation.

FIGS. 25A and 25B depict a listing of at least a portion of the steps of an exemplary method 300 for unloading a top tool 110 and a bottom tool 112 from a press machine 114. Variations to the steps may be performed. The steps may be performed in the order shown in FIGS. 25A and 25B, or they may be performed in a different order. Furthermore, some steps may be performed concurrently as opposed to sequentially. In addition, some steps may be optional or may not be performed.

Referring to step 301 and FIG. 22, a cart 12 is latched to a press machine 114. The cart 12 generally provides temporary support of the tools 110, 112 during loading and unloading of the top tool 110 and the bottom tool 112 into and out of the press machine 114 and its details are described above. The top tool 110 performs shaping, scoring, folding, cutting, or the like on an upper surface or aspect of the blank during production and its details are described above. The bottom tool 112 performs shaping, scoring, folding, cutting, or the like on a lower surface or aspect of the blank during production and its details are described above. The press machine 114, as shown in FIGS. 1, 8, 9, 11, and 13-23, generally provides a pressing operation, that is, applying pressure, to a blank such as paper or plastic film or sheet in order to shape, score, fold, cut, and so forth, the blank during the production of a product, such as a plate or covered container. The cart 12 includes a latch assembly 74 which is positioned on a front wall and couples to the press machine 114 during loading and unloading of the tools 110, 112 to maintain a position of the cart 12. The cart 12 further includes a plurality of feet 70 that extend from, and retract into, the cart 12. The feet 70 provide stability to the cart 12 when they are extended during loading and unloading of the tools 110, 112.

Referring to step 302, an upper platen 14 is lowered and a lower platen 24 is raised so that the top tool 110 rests upon the bottom tool 112.

Referring to step 303 and FIG. 21, a long tool coupler 80 is connected to the top tool 110 and the bottom tool 112. The long tool coupler 80 includes first and second telescopic arms that are rotatably connected to a hinge. The hinge removably connects to a short tool coupler 78, the free end of the first arm removably connects to the bottom tool 112, and the free end of the second arm removably connects to the top tool 110. The short tool coupler 78 includes an elongated upright block which is connected to the conveyor mechanism 76 and moves forward and backward when the conveyor mechanism 76 is activated (by turning the crank handle).

Referring to step 304, first and second shot pins 44, 46 on an upper platen 14 are retracted from first and second bushings 40, 42 on a top tool 110. The first and second shot pins 44, 46 are roughly cylindrical shaped and have a tapered tip. The first and second shot pins 44, 46 are spaced apart from one another and positioned in openings along a center line on the lower surface of the upper platen 14. The first and second shot pins 44, 46 are actuated to retract inward into the lower surface. The first and second bushings 40, 42 are positioned on an upper surface of the top tool 110.

Referring to step 305, a plurality of top tool clamps 82 are disengaged or actuated to unclamp the top tool 110 from the upper platen 14. The top tool clamps 82 are T-knob shaped, having a cylindrical body and a circumferential flange along a top edge. The top tool clamps 82 are positioned in two spaced apart rows on the lower surface, with four top tool clamps 82 in each row as an exemplary configuration. The top tool clamps 82 are actuated to extend outward from the lower surface so that the flanges are at a first height during loading and unloading of the top tool 110. The top tool clamps 82 are positioned in first and second T-slots 36, 38 on the top tool 110.

Referring to step 306, third and fourth shot pins 62, 64 on a lower platen 24 are retracted from third and fourth bushings 58, 60 on a bottom tool 112. The third and fourth shot pins 62, 64 are roughly cylindrical shaped and have a tapered tip. The third and fourth shot pins 62, 64 are spaced apart from one another and positioned in openings along a center line on the upper surface. third and fourth shot pins 62, 64. The third and fourth shot pins 62, 64 are actuated to retract inward into the upper surface. The third and fourth bushings 58, 60 are positioned on a lower surface of the bottom tool 112.

Referring to step 307, a plurality of bottom tool clamps 100 are disengaged or actuated to unclamp the bottom tool 112 from the lower platen 24. The bottom tool clamps 100, similar to the top tool clamps 82, are T-knob shaped, having a cylindrical body and a circumferential flange along a top edge. The bottom tool clamps 100 are positioned in two spaced apart rows on the upper surface, with four bottom tool clamps 100 in each row as an exemplary configuration. The bottom tool clamps 100 are actuated to extend outward from the upper surface so that the flanges are at a first height during loading and unloading of the bottom tool 112.

Referring to step 308, the upper platen 14 is raised and the lower platen 24 is lowered. Thus, the top tool 110 is spaced apart from the bottom tool 112.

Referring to step 309, first and second transport rails 116A, 116B are positioned or moved in close proximity to one another.

Referring to step 310, a pair of upper platen loading arms 16, 18, 20, 22 on an upper platen 14 and a pair of lower platen loading arms 26, 28, 30, 32 on a lower platen 24 are rotated such that they extend outward. The upper platen 14 retains the top tool 110 during operation of the press machine 114 and its details are described above. The upper platen loading arms 16, 18, 20, 22 include a first upper platen loading arm 16 positioned on a left side of the front surface of the upper platen 14, a second upper platen loading arm 18 positioned on a right side of the front surface of the upper platen 14, a third upper platen loading arm 20 positioned on a right side of the rear surface of the upper platen 14, and a fourth upper platen loading arm 22 positioned on a left side of the rear surface of the upper platen 14.

Referring to step 311 and FIG. 20, the top tool 110 and the bottom tool 112 are moved a first distance towards the cart 12. The tools 110, 112 are moved by turning the crank handle on the cart 12 so that the short tool coupler 78 and the long tool coupler 80 pull the top tool 110 and the bottom tool 112 toward the cart 12. The tools 110, 112 are moved until at forward edge of the tools 110, 112 is at, or near, the edge of the upper platen loading arms 16, 18 and the lower platen loading arms 26, 28, or at least until the tools 110, 112 are in front of the transport rails 116A, 116B.

Referring to step 312 and FIG. 19, the upper platen 14 is lowered and the lower platen 24 is raised so that the top tool 110 rests on the bottom tool 112.

Referring to step 313 and FIG. 19, the long tool coupler 80 is removed. The short tool coupler 78 is connected to the bottom tool 112.

Referring to step 314 and FIG. 18, the top tool 110 and the bottom tool 112 are pulled onto the cart 12. The tools 110, 112 are moved by turning the crank handle on the cart 12.

Referring to step 315 and FIGS. 15 and 16, the top tool 110 and the bottom tool 112 are removed from the cart 12. The tools 110, 112 may be removed from the cart using a fork lift and returned to a storage location.

Referring to step 316 and FIG. 14, the cart 12 is unlatched from the press machine 114, and the feet 70 are raised. The cart 12 is then moved to another location away from the press machine 114. In addition, the upper platen loading arms 16, 18, 20, 22 and the lower platen loading arms 26, 28, 30, 32, at least on the front side, are rotated sideways.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for loading and unloading a top tool and a bottom tool in a press machine, the system comprising:
a cart to temporarily support the top tool and the bottom tool, the cart including
a latch assembly to couple the cart to the press machine, and
a conveyor mechanism including left and right rails and chain-linked rungs positioned therebetween;
an upper platen positioned in the press machine and configured to retain the top tool, the upper platen including a plurality of top tool clamps to clamp to first and second T-slots of the top tool;
a first upper platen loading arm coupled to a left side of a front surface of the upper platen, the first upper platen loading arm including a first plurality of rollers to fit in a left roller slot of the top tool;
a second upper platen loading arm coupled to a right side of the front surface of the upper platen, the second upper platen loading arm including a second plurality of rollers to fit in a right roller slot of the top tool;
a lower platen positioned in the press machine beneath the upper platen and configured to retain the bottom tool, the lower platen including a plurality of bottom tool clamps to clamp to third and fourth T-slots of the bottom tool;
a first lower platen loading arm positioned on a left side of a front surface of the lower platen, the first lower platen loading arm including a first track to fit into the third T-slot of the bottom tool; and
a second lower platen loading arm positioned on a right side of the front surface of the lower platen, the second lower platen loading arm including a second track to fit into the fourth T-slot of the bottom tool.

2. The system of claim 1, further comprising a short tool coupler configured to connect to the conveyor mechanism and the bottom tool for a first distance during loading and unloading of the top tool and the bottom tool.

3. The system of claim 2, further comprising a long tool coupler configured to connect the short tool coupler to the top tool and the bottom tool for a second distance during loading and unloading of the top tool and the bottom tool.

4. The system of claim 1, wherein the upper platen further includes
a left side strip having a third plurality of rollers that fit in the left roller slot of the top tool, and
a right side strip having a fourth plurality of rollers that fit in the right roller slot of the top tool.

5. The system of claim 1, wherein the upper platen further includes first and second shot pins each having a roughly cylindrical shape and a tapered tip, the first and second shot pins to fit within first and second bushings, respectively, in the top tool to provide alignment of the top tool.

6. The system of claim 1, wherein the top tool clamps are positioned at a first height during loading and unloading of the top tool and at a second height to clamp the top tool, and the bottom tool clamps are positioned at the first height during loading and unloading of the bottom tool and at the second height to clamp the bottom tool.

7. The system of claim 1, wherein the lower platen further includes third and fourth shot pins each having a roughly cylindrical shape and a tapered tip, the third and fourth shot pins to fit within third and fourth bushings, respectively, in the bottom tool to provide alignment of the bottom tool.

8. The system of claim 1, wherein the first upper platen loading arm and the second upper platen loading arm each are configured to rotate through a range of approximately 180 degrees including a first rotational position of approximately 90 degrees for loading and unloading of the top tool and a second rotational position of approximately 0 degrees or approximately 180 degrees for operation of the press machine.

9. The system of claim 1, wherein the first lower platen loading arm and the second lower platen loading arm each are configured to rotate through a range of approximately 180 degrees including a first rotational position of approximately 90 degrees for loading and unloading of the bottom tool and a second rotational position of approximately 0 degrees or approximately 180 degrees for operation of the press machine.

10. A method for loading a top tool and a bottom tool in a press machine, the method comprising:
latching a cart to the press machine;
placing the top tool and the bottom tool on the cart;
rotating first and second upper platen loading arms on an upper platen and first and second lower platen loading arms on a lower platen such that the first and second upper platen loading arms and the first and second lower platen loading arms each extend outward;
moving the top tool and the bottom tool by a first distance so that the top tool engages with the upper platen loading arms and the bottom tool engages with the lower platen loading arms;
raising the upper platen and lowering the lower platen, which separates the top tool and the bottom tool;
moving the top tool and the bottom tool by a second distance so that the bottom tool engages with a stop on the lower platen;
engaging the top tool clamps to clamp the top tool to the upper platen; and
engaging the bottom tool clamps to clamp the bottom tool to the lower platen.

11. The method of claim 10, further comprising:
connecting a short tool coupler to the bottom tool before moving the top tool and the bottom tool by the first distance;
disconnecting the short tool coupler after moving the top tool and the bottom tool by the first distance; and
connecting a long tool coupler to the short tool coupler, the top tool, and the bottom tool before moving the top tool and the bottom tool by the second distance.

12. The method of claim 10, further comprising extending first and second shot pins on the upper platen into first and second bushings, respectively, on the top tool to align the top tool on the upper platen and extending third and fourth shot pins on the lower platen into third and fourth bushings, respectively, on the bottom tool to align the bottom tool on the lower platen.

13. The method of claim 10, wherein
the first upper platen loading arm includes a first plurality of rollers that fit into a left roller slot of the top tool,
the second upper platen loading arm includes a second plurality of rollers that fit into a right roller slot of the top tool, and
the upper platen includes a left side strip having a third plurality of rollers that fit in the left roller slot of the top tool and a right side strip having a fourth plurality of rollers that fit in the right roller slot of the top tool.

14. The method of claim 10, further comprising lowering the upper platen and raising the lower platen before moving the top tool and the bottom tool by the first distance.

15. The method of claim 10, further comprising
positioning first and second transport rails in close proximity to one another after the cart is latched to the press machine; and
positioning first and second transport rails spaced apart from one another after the tool coupler is removed from the top tool and the bottom tool.

16. The method of claim 10, wherein
a first portion of the top tool clamps fit in a first T-slot of the top tool,
a second portion of the top tool clamps fit in a second T-slot of the top tool,
a first portion of the bottom tool clamps fit in a third T-slot of the bottom tool, and
a second portion of the bottom tool clamps fit in a fourth T-slot of the bottom tool.

17. A method for unloading a top tool and a bottom tool in a press machine, the method comprising:
latching a cart to the press machine;
raising an upper platen and lowering a lower platen;
rotating first and second upper platen loading arms on an upper platen and first and second lower platen loading arms on a lower platen such that the first and second upper platen loading arms and the first and second lower platen loading arms each extend outward;
disengaging a plurality of top tool clamps to unclamp the top tool from the upper platen;
disengaging a plurality of bottom tool clamps to unclamp the bottom tool from the lower platen;
moving the top tool and the bottom tool toward the cart;
raising the lower platen and lowering the upper platen;
moving the top tool and the bottom tool onto the cart; and
removing the top tool and the bottom tool from the cart.

18. The method of claim 17, further comprising retracting first and second shot pins on the upper platen from first and second bushings, respectively, on the top tool, and retracting third and fourth shot pins on the lower platen from third and fourth bushings, respectively, on the bottom tool.

19. The method of claim 17, further comprising connecting a long tool coupler to the top tool and the bottom tool before moving the top tool and the bottom tool toward the cart.

20. The method of claim 17, further comprising disconnecting the long tool coupler and connecting a short tool coupler to the bottom tool before moving the top tool and the bottom tool onto the cart.
